(19) United States
(12) Patent Application Publication
(10) Pub. No.: US 2018/0037307 A1
(43) Pub. Date: Feb. 8, 2018

(54) ULTRA-HIGH PRESSURE REGULATOR AND A METHOD OF USING THE SAME

(71) Applicant: ADA Technologies, Inc., Littleton, CO (US)

(72) Inventors: Andrew Timon Brewer, Wheatridge, CO (US); Thierry Carriere, Littleton, CO (US)

(21) Appl. No.: 15/411,781

(22) Filed: Jan. 20, 2017

Related U.S. Application Data
(60) Provisional application No. 62/281,843, filed on Jan. 22, 2016.
(60) Provisional application No. 62/280,916, filed on Jan. 20, 2016.

(51) Int. Cl. B63C 11/22; A62B 9/02; G05D 16/16

(52) U.S. Cl. CPC B63C 11/2236; G05D 16/166; B63C 11/2209; B63C 11/2227; A62B 9/022

(57) ABSTRACT

A need exists for a tank regulator that can reduce a pressure of more than about 4,300 psi to a much lower pressure. The present disclosure describes a piston regulator that allows for pressure to be reduced from an inlet pressure of about 5,000 psi or more to outlet pressure of about 2,000 psi or less. The regulator includes intermediate chambers to provide step-down pressures along the piston. The internal chambers enable to hold pressure differentials between the high-pressure inlet and the low-pressure outlet. The pressure in the intermediate chambers is maintained by a pressure-limiting valve to control the pressure differentials across piston seals. These seals allow the piston to actuate while maintaining a seal between the various pressure chambers.

### CROSS REFERENCE TO RELATED APPLICATIONS

The present application claims priority under 35 U.S.C. §119 to U.S. Provisional Patent Application Nos. 62/280,916, which was filed Jan. 20, 2016, and 62/281,843 which was filed Jan. 22, 2016, both entitled “Ultra-High Pressure Regulator Device and Method of Use,” and each of which is incorporated in its entirety herein by this reference.

### STATEMENT REGARDING FEDERALLY SPONSORED RESEARCH OR DEVELOPMENT

The invention was made with Government support under Contract No. N00024-15-C-4024 awarded by the United States Navy. The Government has certain rights in the invention.

### FIELD

The invention relates generally to gas pressure regulation, such as ultra-high pressure regulation and particularly to a ultra-high gas pressure regulator and a method of using the same.

### BACKGROUND

A pressure regulator reduces an input pressure of a fluid to a desired output pressure. Generally, the flow of gas through the regulator matches to the demand for the gas while maintaining a constant output gas pressure. The main components of a pressure regulator typically include a restricting element, a loading element, and a measuring element. The restricting element is usually a valve capable of providing a variable restriction to fluid flow. The loading element usually applies a force to the restricting element. The measuring element typically determines when the inlet flow is equal to the outlet flow.

Scuba regulators are designed to reduce pressurized breathing gas from a high-pressure cylinder to a pressure that can be inhaled on-demand by a diver. The regulator is capable of supplying breathable gas at a pressure of about 120 to 150 psi from a pressurized tank at a pressure of about 3,000 psi. As such, a series of pressure regulators are employed to reduce the pressure to values that can be delivered for normal respiration. To begin, a cylinder valve (typically with a yoke or DIN fitting) is attached to a diving cylinder to control the flow of high-pressure gas out of the cylinder. A first-stage regulator is mounted on the cylinder valve to reduce the pressure from the tank pressure (up to about 3,000 psi in a traditional tank) to about 120 to about 150 psi above ambient pressure. First-stage scuba regulators employ either a piston or diaphragm sensing element to control outlet gas pressure via flow through a variable-sized orifice. Regardless of type, each sensing element functions by balancing pressure to open and close the valve.

Diaphragm regulators are resistant to freezing due to component containment, but are not well suited for high-pressure application. Alternatively, piston regulators are much more robust in design and function. Gas leaving the first-stage regulator at an intermediate pressure is then transferred to a second-stage regulator, which provides breathing gas to a diver's mouth on-demand at a reduced breathable pressure.

### SUMMARY

These and other needs are addressed by the various embodiments and configurations of the present invention.

In accordance with some embodiments is a regulator. The regulator can include a first regulator channel configured to accept a first piston generally having a first piston groove, a last piston groove, and an intermediate piston groove positioned between the first and last piston grooves. The regulator can also include a gas inlet channel interconnected to the first regulator channel and having a gas inlet channel pressure. The last piston groove is commonly positioned adjacent to the gas inlet channel. The last piston groove can contain a last dynamic pressure-sealing element having opposing upper and lower last dynamic pressure-sealing element surfaces. The regulator can include a gas outlet channel having a gas outlet channel pressure. The gas inlet and the gas outlet channels are generally in fluid communication. The first piston groove is typically positioned adjacent to the gas outlet channel. The first piston groove contains a first dynamic pressure-sealing element having opposing upper and lower first dynamic pressure-sealing element surfaces. The intermediate piston groove usually contains an intermediate dynamic sealing element having opposing upper and lower intermediate dynamic sealing element surfaces. The regulator can also include a second regulator channel generally having a second fluid pressure. The second regulator channel can commonly be in fluid communication with the upper last dynamic pressure-sealing element surface and to the lower intermediate dynamic pressure-sealing element surface. The lower last dynamic pressure-sealing element surface is commonly at the gas inlet pressure. The upper first dynamic pressure-sealing element surface is commonly at the gas outlet pressure. Moreover, the upper last dynamic pressure-sealing element surface and the lower intermediate dynamic pressure-sealing element surface are at the second fluid pressure. The lower first dynamic pressure-sealing element surface and the upper intermediate dynamic pressure-sealing element are at a first fluid pressure. Furthermore, the inlet pressure is greater than one or both of the first and second fluid pressures. Moreover, the outlet pressure is no greater than one or both of first and second fluid pressures.

The first dynamic pressure-sealing element is usually positioned between upper and lower first back-up rings. The intermediate dynamic pressure-sealing element is commonly positioned between upper and lower intermediate back-up rings. The last dynamic pressure-sealing element is typically positioned between upper and lower last back-up rings. The first dynamic pressure-sealing element can be an o-ring. The first dynamic pressure-sealing element can be a nitrile o-ring. The intermediate dynamic pressure-sealing element can be a nitrile o-ring. The last dynamic pressure-sealing element can be a nitrile o-ring.

Commonly, the gas outlet channel pressure can be from about 500 psi to about 5000 psi. More commonly, the gas outlet channel pressure can be from about 1000 psi to about 3000 psi.

Typically, the gas inlet channel pressure can be from about 4,500 psi to about 10,000 psi. More typically, the gas inlet channel pressure can be from about 5,000 psi to about 10,000 psi.

Commonly, the second fluid pressure can be from about 1,500 to about 5,000 psi. More commonly, the second fluid pressure can be from about 2,000 to about 5,000 psi. Even more commonly, the second fluid pressure can be from about 3,000 to about 5,000 psi. Yet even more commonly, the second first fluid pressure can be about 5,000 psi. Still yet even more commonly, the second fluid pressure can be about 4,000 psi. Yet still even more commonly, the second fluid pressure can be about 6,000 psi.

The first fluid pressure can generally be about 1 atm at STP. More generally the first fluid pressure can be from about 0.8 to about 1 atm at STP.

In some embodiments, the second regulator channel can be configured to accept a pressure-limiting-valve plug, a pressure-limiting-valve spring cap, a pressure-limiting-valve spring, a pressure-limiting-valve push rod, a pressure-limiting-valve piston, and a pressure-limiting-valve retainer. Furthermore, the pressure-limiting-valve plug can seal the pressure-limiting-valve spring cap, pressure-limiting-valve spring, pressure-limiting-valve push rod, pressure-limiting-valve piston, and pressure-limiting-valve retainer in the second regulator channel. The pressure-limiting spring cap can have a spring cap void. Moreover, the pressure-limiting-valve push rod can have a push rod stem interconnected to a push rod head. A portion of the push rod stem is typically contained within the spring cap void. Furthermore, the pressure-limiting-valve spring can be positioned between the pressure-limiting valve spring cap and the push rod head. The push rod head can be in contact with one end of the pressure-limiting-valve piston. The pressure-limiting-valve retainer can be in contact with the other end of pressure-limiting-valve piston.

The first regulator channel can be configured to accept, in addition to the first piston, one or more piston lock washers, a loading force element, a piston seat, and a piston seat retainer. The one or more lock washers can contain one or more lock washer voids and/or channels. Moreover, first piston can have a piston shaft. The first piston shaft can have at one end a piston arm and at other end a piston head. The piston arm and piston head can be in an opposing relationship. The first piston can be positioned between the one or more lock washers and the piston seat. The loading-force element can contain a loading-force element void. A portion of the piston shaft can be positioned in the loading-force element void. The piston seat can be positioned between the piston head and the piston seat retainer.

In accordance with some embodiments is a system having an inlet channel for introducing a pressurized gas having an inlet gas pressure. The inlet gas pressure can apply a lifting force to a first piston contained within a first regulator channel. The applied lifting force can also break a gas-tight seal between a first piston seat and the first piston. Moreover, the gas inlet pressure can also apply the inlet gas pressure to a lower last dynamic pressure-sealing element surface of a last dynamic pressure-sealing element. Furthermore, the inlet gas pressure can introduce the pressurized gas into a first piston channel to flow the pressurized gas to an outlet and convert the inlet gas pressure to an outlet gas pressure. The inlet gas pressure can be greater than outlet pressure. Moreover, the first piston channel traverses a first piston longitudinal axis. The system can also include a second regulator channel for applying a second fluid pressure to both the upper last dynamic pressure-sealing element surface and to a lower intermediate dynamic pressure-sealing element surface. The upper and lower last dynamic pressure-sealing element surfaces are typically in an opposing relationship. The inlet gas pressure can be applied to the lower last dynamic pressure-sealing element surface. Moreover, the outlet gas pressure can be applied to upper first dynamic pressure-sealing element surface. The system can generally include a second first gas to apply a first fluid pressure to lower first dynamic pressure-sealing element surface and the upper intermediate dynamic pressure-sealing element surface. The inlet pressure can be greater than one or both of the first and second fluid pressures. The outlet pressure can be no greater than one or both of first and second fluid pressures.

The first dynamic pressure-sealing element is usually positioned between upper and lower first back-up rings. The intermediate dynamic pressure-sealing element is commonly positioned between upper and lower intermediate back-up rings. The last dynamic pressure-sealing element is typically positioned between upper and lower last back-up rings. The first dynamic pressure-sealing element can be an o-ring. The first dynamic pressure-sealing element can be a nitrile o-ring. The intermediate dynamic pressure-sealing element can be a nitrile o-ring. The intermediate dynamic pressure-sealing element can be a nitrile o-ring. The last dynamic pressure-sealing element can be a nitrile o-ring. The last dynamic pressure-sealing element can be a nitrile o-ring.

Commonly, the pressure applied by the outlet gas pressure can be from about 500 psi to about 5000 psi. More commonly, the pressure applied by the outlet gas pressure is from about 1000 psi to about 3000 psi.

Generally, pressure applied by the inlet gas pressure can be from about 4,500 psi to about 10,000 psi. More generally, the pressure applied by the inlet gas pressure can be from about 5,000 psi to about 10,000 psi.

Commonly, the pressure applied by the second fluid pressure can be from about 1,500 to about 5,000 psi. More commonly, the pressure applied by the second fluid pressure can be from about 2,000 to about 5,000 psi. Even more commonly, the pressure applied by the second fluid pressure can be from about 3,000 to about 5,000 psi. Still yet even more commonly, the pressure applied by the second fluid pressure is about 5,000 psi. Still yet even more commonly, the pressure applied by the second fluid pressure can be about 4,000 psi. Yet still even more commonly, the pressure applied by the second fluid pressure can be about 6,000 psi.

Commonly, the pressure applied by the second fluid pressure can be from about 1,500 to about 5,000 psi. More commonly, the pressure applied by the second fluid pressure can be from about 2,000 to about 5,000 psi. Even more commonly, the pressure applied by the second fluid pressure can be from about 3,000 to about 5,000 psi. Still yet even more commonly, the pressure applied by the second fluid pressure is about 5,000 psi. Still yet even more commonly, the pressure applied by the second fluid pressure can be about 4,000 psi. Yet still even more commonly, the pressure applied by the second fluid pressure can be about 6,000 psi.

The pressure applied by the first fluid pressure can typically be about 1 atm at STP. More typically, the pressure applied by the first fluid pressure can be from about 0.8 to about 1 atm at STP.

In some embodiments, the second regulator channel can be configured to accept a pressure-limiting-valve plug, a pressure-limiting-valve spring cap, a pressure-limiting-valve spring, a pressure-limiting-valve push rod, a pressure-limiting-valve piston, and a pressure-limiting-valve retainer. Furthermore, the pressure-limiting-valve plug can seal the pressure-limiting-valve spring cap, pressure-limiting-valve spring, pressure-limiting-valve push rod, pressure-limiting-valve piston, and pressure-limiting-valve retainer in the second regulator channel. The pressure-limiting spring cap can have a spring cap void. Moreover, the pressure-limiting-valve push rod can have a push rod stem interconnected to a push rod head. A portion of the push rod stem can typically contained within the spring cap void. Furthermore, the pressure-limiting-valve spring can be positioned between the pressure-limiting valve spring cap and the push rod head. The push rod head can be in contact with one end of the pressure-limiting-valve piston. The pressure-limiting-valve retainer can be in contact with the other end of pressure-limiting-valve piston.

The first regulator channel can be configured to accept, in addition to the first piston, one or more piston lock washers, a loading force element, a piston seat, and a piston seat retainer. The one or more lock washers can contain one or more lock washer voids and/or channels. Moreover, first piston can have a piston shaft. The piston shaft can have at one end a piston arm and at other end a piston head. The piston arm and piston head can be in an opposing relationship. The first piston can be positioned between the one or more lock washers and the piston seat. The loading-force element can contain a loading-force element void. A portion of the piston shaft can be positioned in the loading-force element void. The piston seat can be positioned between the piston head and the piston seat retainer.

In accordance with some embodiments is a device that includes a first regulator channel configured to accept a first piston having a first piston groove, a last piston groove, and an intermediate piston groove positioned between the first and last piston grooves. The last piston groove can contain a last dynamic pressure-sealing element having upper and lower last dynamic pressure-sealing element surfaces. The upper last dynamic pressure-sealing element surface can be subjected to the second pressure. The lower last dynamic pressure-sealing element surface can be subjected to a fourth pressure. The second and fourth pressures exert different pressure forces on the last dynamic pressure-sealing element. The intermediate piston groove can contain a intermediate dynamic pressure-sealing element having upper and lower intermediate dynamic pressure-sealing element surfaces. The upper intermediate dynamic pressure-sealing element surface can be subjected to the first pressure. The lower intermediate dynamic pressure-sealing element surface can be subjected to a second pressure. The second and first pressures can exert different pressure forces on the intermediate dynamic pressure-sealing element. The first piston groove can contain a first dynamic pressure-sealing element having upper and lower first dynamic pressure-sealing element surfaces. The upper first dynamic pressure-sealing element surface can be subjected to a third pressure. The lower first dynamic pressure-sealing element surface can be subjected to the first pressure. The third and first pressures exert different pressure forces on the first dynamic pressure-sealing element. The fourth pressure is more than first pressure.

In some embodiments, the first regulator channel can be configured to accept in addition to the first piston, one or more piston lock washers, a loading force element, and a piston seat.

The first dynamic pressure-sealing element is usually positioned between upper and lower first back-up rings. The intermediate dynamic pressure-sealing element is commonly positioned between upper and lower intermediate back-up rings. The last dynamic pressure-sealing element is typically positioned between upper and lower last back-up rings. The first dynamic pressure-sealing element can be an o-ring. The first dynamic pressure-sealing element can be a nitrile o-ring. The intermediate dynamic pressure-sealing element can be an o-ring. The intermediate dynamic pressure-sealing element can be a nitrile o-ring. The last dynamic pressure-sealing element can be an o-ring. The last dynamic pressure-sealing element can be a nitrile o-ring.

In some embodiments, the device can further include a first upper back-up ring. The first upper back-up ring can a first upper back-up flat ring surface and a upper first back-up ring contoured surface. The first upper back-up flat ring surface and the first upper back-up ring contoured surface can be in an opposing relationship. Moreover, the device can also include a first lower back-up ring. The first lower back-up ring can have a first lower back-up flat ring surface and a lower first back-up ring contoured surface. The first lower back-up flat ring surface and the first lower back-up ring contoured surface can generally be in an opposing relationship. The first dynamic pressure-sealing element can be in contact with the upper first back-up ring contoured surface and the lower first back-up ring contoured surface.

In some embodiments, the device can further include an intermediate upper back-up ring. The intermediate upper back-up ring can have an intermediate upper back-up flat ring surface and an upper intermediate back-up ring contoured surface. The intermediate upper back-up flat ring surface and the intermediate upper back-up ring contoured surface can be in an opposing relationship. Moreover, the device can also include an intermediate lower back-up ring. The intermediate lower back-up ring can have an intermediate lower back-up flat ring surface and a lower intermediate back-up ring contoured surface. The intermediate lower back-up flat ring surface and the intermediate lower back-up ring contoured surface can be in an opposing relationship.

In some embodiments, the intermediate dynamic pressure-sealing element can be an o-ring. The intermediate dynamic pressure-sealing element is usually in contact with the upper intermediate back-up ring contoured surface and the lower intermediate back-up ring contoured surface.

In accordance with some embodiments, the device can further include a last upper back-up ring. The last upper back-up ring can have a last upper back-up flat ring surface and an upper last back-up ring contoured surface. The last upper back-up flat ring surface and the last upper back-up ring contoured surface can be in an opposing relationship. Moreover, the device can further include a last lower back-up ring. The last lower back-up ring can have a last lower back-up flat ring surface and a lower last back-up ring contoured surface. The last lower back-up flat ring surface and the last lower back-up ring contoured surface can be in an opposing relationship.

In some embodiments, the last dynamic pressure-sealing element can be an o-ring. The last dynamic pressure-sealing element is typically in contact with the upper last back-up ring contoured surface and the lower last back-up ring contoured surface.

Commonly, the first, second, third and fourth pressures are gas pressures. The first gas can have a first gas pressure. That is, the first gas can exert a first gas pressure. The second gas can have a second gas pressure. That is, the second gas can exert a second gas pressure. The third gas can have a third gas pressure. That is, the third gas can exert a third gas pressure. The fourth gas can have a fourth gas pressure. That is, the fourth gas can exert a fourth gas pressure.

In accordance with some embodiments of the present disclosure is a device that includes a first regulator channel configured to accept a first piston. The first piston can have a first piston groove, a last piston groove, and an intermediate piston groove positioned between the first and last piston grooves. Furthermore, the first piston can have an exterior piston wall. The first regulator channel can have a first regulator channel wall. The first piston groove can contain a first dynamic pressure-sealing element, the first dynamic pressure-sealing element can have upper and lower first dynamic pressure-sealing element surfaces. The second piston groove can contain a second dynamic pressure-sealing element, the second dynamic pressure sealing element can have upper and lower second dynamic pressure-sealing element surfaces. The third piston groove can contain a third dynamic pressure-sealing element, the third dynamic pressure sealing element can have upper and lower third dynamic pressure-sealing element surfaces.

In accordance with some embodiments is a second regulator volume defined by a second portion of the exterior piston wall, a second portion of the first regulator channel wall, the lower first dynamic pressure-sealing element surface, and the upper intermediate dynamic pressure-sealing element surface. The second regulator volume typically contains a first fluid at a first fluid pressure.

In accordance with some embodiments is a first regulator volume defined by a first portion of the exterior piston wall, a first portion of the first regulator channel wall, the lower intermediate dynamic pressure-sealing element surface, and the upper last dynamic pressure-sealing element surface. The first regulator volume typically contains a second fluid at a second fluid pressure.

Some embodiments can include a second regulator channel containing a second fluid at a second fluid pressure. The second regulator channel cam be in fluid communication with the second regulator volume. Moreover, the second regulator volume can contain the second fluid at the second fluid pressure. The first and second fluid pressures can differ in pressure.

In some embodiments, the device can further include a third regulator volume. The third regulator volume can contain the second fluid at a third fluid pressure.

In some embodiments, the device can further include a fourth regulator volume. The fourth regulator volume can contain the second fluid at a fourth fluid pressure.

Commonly, the fourth fluid pressure is greater than the third fluid pressure. Generally, the third fluid is a breathable gas supplied by a high-pressure gas source. The high-pressure gas source can usually be a high-pressure tank. More usually, the high-pressure tank can be a self-contained breathing apparatus tank.

Commonly, the third fluid pressure can be from about 500 psi to about 5000 psi. More commonly, the gas outlet channel pressure can be from about 1000 psi to about 3000 psi.

Typically, the fourth fluid pressure can be from about 4,500 psi to about 10,000 psi. More typically, the fourth fluid pressure can be from about 5,000 psi to about 10,000 psi. Even more typically, the fourth fluid pressure is from about 6,000 to about 10,000 psi.

Commonly, the second fluid pressure can be from about 1,500 to about 5,000 psi. More commonly, the second fluid pressure can be from about 2,000 to about 5,000 psi. Even more commonly, the second fluid pressure can from about 3,000 to about 5,000 psi. Even more commonly, the second fluid pressure can be about 5,000 psi. Yet even more commonly, the second fluid pressure can be about 4,000 psi. Still yet even more commonly, the second fluid pressure can be about 6,000 psi.

The first fluid pressure can generally be about 1 atm at STP. More generally the first fluid pressure can be from about 0.8 to about 1 atm at STP. Typically, the first fluid pressure is about 1 atm when the first regulator volume is constructed. More typically, the first fluid pressure is about from about 0.8 to about 1 atm at STP when the first regulator volume is constructed.

In some embodiments, the second regulator channel can be configured to accept a pressure-limiting-valve plug, a pressure-limiting-valve spring cap, a pressure-limiting-valve spring, a pressure-limiting-valve push rod, a pressure-limiting-valve piston, and a pressure-limiting-valve retainer. Furthermore, the pressure-limiting-valve plug can seal the pressure-limiting-valve spring cap, pressure-limiting-valve spring, pressure-limiting-valve push rod, pressure-limiting-valve piston, and pressure-limiting-valve retainer in the second regulator channel. The pressure-limiting spring cap can have a spring cap void. Moreover, the pressure-limiting-valve push rod can have a push rod stem interconnected to a push rod head. A portion of the push rod stem is typically contained within the spring cap void. Furthermore, the pressure-limiting-valve spring can be positioned between the pressure-limiting valve spring cap and the push rod head. The push rod head can be in contact with one end of the pressure-limiting-valve piston. The pressure-limiting-valve retainer can be in contact with the other end of pressure-limiting-valve piston.

The first regulator channel can be configured to accept, in addition to the first piston, one or more piston lock washers, a loading force element, a piston seat, and a piston seat retainer. The one or more lock washers can contain one or more lock washer voids and/or channels. Moreover, first piston can have a piston shaft. The piston shaft can have at one end a piston arm and at other end a piston head. The piston arm and piston head can be in an opposing relationship. The first piston can be positioned between the one or more lock washers and the piston seat. The loading-force element can contain a loading-force element void. A portion of the piston shaft can be positioned in the loading-force element void. The piston seat can be positioned between the piston head and the piston seat retainer.

Typically, the first and second fluids are gases. More typically, the first and second fluids are breathable gases. Even more typically, the first and second fluids are breathable gases having from about 75 to about 80 v/v % nitrogen, from about 19 to about 24 v/v % oxygen. Yet even more typically, the first and second fluids differ in one or more of composition and source. Generally, the second fluid source is a high-pressure tank. Usually, the first fluid source is the ambient atmosphere when the first regulator volume is constructed.

In some embodiments, the device can further include a first upper back-up ring. The first upper back-up ring can have a first upper back-up flat ring surface and an upper first back-up ring contoured surface. The first upper back-up flat ring surface and the first upper back-up ring contoured surface can be in an opposing relationship. Moreover, the device can also include a first lower back-up ring. The first lower back-up ring can have a first lower back-up flat ring surface and a lower first back-up ring contoured surface. The first lower back-up flat ring surface and the first lower back-up ring contoured surface can generally be in an opposing relationship. The first dynamic pressure-sealing element can be in contact with the upper first back-up ring contoured surface and the lower first back-up ring contoured surface.

In some embodiments, the device can further include an intermediate upper back-up ring. The intermediate upper back-up ring can have an intermediate upper back-up flat ring surface and an upper intermediate back-up ring contoured surface. The intermediate upper back-up flat ring surface and the intermediate upper back-up ring contoured surface can be in an opposing relationship. Moreover, the device can also include an intermediate lower back-up ring. The intermediate lower back-up ring can have an intermediate lower back-up flat ring surface and a lower intermediate back-up ring contoured surface. The intermediate lower back-up flat ring surface and the intermediate lower back-up ring contoured surface can be in an opposing relationship.

In some embodiments, the intermediate dynamic pressure-sealing element can be an o-ring. The intermediate dynamic pressure-sealing element is usually in contact with the upper intermediate back-up ring contoured surface and the lower intermediate back-up ring contoured surface.

In accordance with some embodiments, the device can further include a last upper back-up ring. The last upper back-up ring can have a last upper back-up flat ring surface and a upper last back-up ring contoured surface. The last upper back-up flat ring surface and the last upper back-up ring contoured surface can be in an opposing relationship. Moreover, the device can further include a last lower back-up ring. The last lower back-up ring can have a last lower back-up flat ring surface and a lower last back-up ring contoured surface. The last lower back-up flat ring surface and the last lower back-up ring contoured surface can be in an opposing relationship.

In some embodiments, the last dynamic pressure-sealing element can be an o-ring. The last dynamic pressure-sealing element is typically in contact with the upper last back-up ring contoured surface and the lower last back-up ring contoured surface.

In accordance with some embodiments is a method that includes in a regulator having first piston positioned in a first regulator channel, the first piston having a first piston channel in fluid communication with a gas inlet having a fourth gas pressure and gas outlet having a third gas pressure. In some embodiments, the first piston is moveable. Some embodiments, in a first piston position, flow of the gas through the first piston channel is substantially blocked when the third gas pressure at the gas outlet is above a selected pressure, and, in a second piston position, flow of the gas through the first piston channel is permitted until the gas pressure at the gas outlet is at the third pressure and less than the selected pressure, maintaining, when the first piston is in both the first and second piston positions, a first gas pressure between a first and intermediate piston grooves. Some embodiments can include maintaining, when the movable piston is in both the first and second piston positions, a second gas pressure between the intermediate and last piston grooves. The intermediate piston groove can be positioned between the first and last piston grooves. The second gas pressure can be greater than the first gas pressure. In some embodiments, each of the first gas pressure, second gas pressure, gas inlet pressure and gas outlet pressure are different from one another.

The present invention can provide a number of advantages depending on the particular configuration.

These and other advantages will be apparent from the disclosure of the invention(s) contained herein.

As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together. When each one of A, B, and C in the above expressions refers to an element, such as X, Y, and Z, or class of elements, such as X₁-Xₙ, Y₁-Yₘ, and Z₁-Zₒ, the phrase is intended to refer to a single element selected from X, Y, and Z, a combination of elements selected from the same class (e.g., X₁ and X₂) as well as a combination of elements selected from two or more classes (e.g., Y₁ and Zₒ).

It is to be noted that the term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the disclosure, brief description of the drawings, detailed description, abstract, and claims themselves.

Unless otherwise noted, all component or composition levels are in reference to the active portion of that component or composition and are exclusive of impurities, for example, residual solvents or by-products, which may be present in commercially available sources of such components or compositions.

All percentages and ratios are calculated by total composition weight, unless indicated otherwise.

It should be understood that every maximum numerical limitation given throughout this disclosure is deemed to include each and every lower numerical limitation as an alternative, as if such lower numerical limitations were expressly written herein. Every minimum numerical limitation given throughout this disclosure is deemed to include each and every higher numerical limitation as an alternative, as if such higher numerical limitations were expressly written herein. Every numerical range given throughout this disclosure is deemed to include each and every narrower numerical range that falls within such broader numerical range, as if such narrower numerical ranges were all expressly written herein. By way of example, the phrase from about 2 to about 4 includes the whole number and/or integer ranges from about 2 to about 3, from about 3 to about 4 and each possible range based on real (e.g., irrational and/or rational) numbers, such as from about 2.1 to about 4.9, from about 2.1 to about 3.4, and so on.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below.

### BRIEF DESCRIPTION OF THE DRAWINGS

The accompanying drawings are incorporated into and form a part of the specification to illustrate several examples of the present disclosure(s). These drawings, together with the description, explain the principles of the disclosure(s). The drawings simply illustrate preferred and alternative examples of how the disclosure(s) can be made and used and are not to be construed as limiting the disclosure(s) to only the illustrated and described examples. Further features and advantages will become apparent from the following, more detailed, description of the various embodiments of the disclosure(s), as illustrated by the drawings referenced below.

FIGS. 1A and 1B depict an elevated view of a regulator according to some embodiments of the present disclosure;

FIG. 2 depicts an exploded view of a regulator according to some embodiments of the present disclosure;

FIG. 3A depicts a top plan view of a regulator according to some embodiments of the present disclosure;

FIG. 3B depicts an elevated view of a regulator of FIGS. 1A and 1B interconnected to a fluid source according to some embodiments of the present disclosure;

FIG. 3C depicts a cross-sectional view of FIG. 3B according to some embodiments of the present disclosure;

FIG. 4A depicts a top plan view of a regulator according to some embodiments of the present disclosure;

FIG. 4B depicts an elevated cut-away section of FIG. 4A according to some embodiments of the present disclosure;

FIG. 5A depicts a top plan view of a regulator according to some embodiments of the present disclosure;

FIG. 5B depicts a cross-sectional view of FIG. 5A according to some embodiments of the present disclosure;

FIG. 5C depicts another cross-sectional view of FIG. 5A according to some embodiments of the present disclosure;

FIG. 5D depicts another cross-sectional view of FIG. 5A according to some embodiments of the present disclosure;

FIG. 6A depicts a top plan view of a regulator according to some embodiments of the present disclosure;

FIG. 6B depicts an elevated cut-away section of FIG. 6A according to some embodiments of the present disclosure;

FIG. 7 depicts a cross-sectional view according to some embodiments of the present disclosure;

FIG. 8 depicts a cross-sectional view according to some embodiments of the present disclosure;

FIG. 9 depicts a cross-sectional view according to some embodiments of the present disclosure;

FIG. 10 depicts a cross-sectional view according to some embodiments of the present disclosure;

FIG. 11 depicts a cross-sectional view according to some embodiments of the present disclosure;

FIG. 12 depicts a cross-sectional view according to some embodiments of the present disclosure;

FIGS. 13A-13C depict a cross-sectional view according to some embodiments of the present disclosure and

FIG. 14 depicts a cross-sectional view according to some embodiments of the present disclosure and

FIG. 15 depicts a cross-sectional view according to some embodiments of the present disclosure.

### DETAILED DESCRIPTION

Current tank first-stage regulators are not designed for operation at pressures above about 4,300 psi. As such, a need exists for a tank regulator that can reduce a pressure of more than about 4,300 psi to a much lower pressure. In accordance with some embodiments of the present disclosure, a pressure regulator as described herein can reduce a gas pressure from one of more than about 4,300 psi to a much lower pressure of about 1,200 psi or lower. Such a gas regulator has a regulator body that contains an interior piston assembly to control fluid flow through the regulator. The gas regulator can provide a substantially controlled outlet pressure gas flow from a gas source having a substantially greater pressure than the controlled outlet pressure, such as but not limited to a gas source pressure of about 10,000 psi and a controlled outlet pressure of about 1,200 psi or lower. Furthermore, the outlet pressure of the pressure regulator remains substantially unaffected by variations in the relatively high pressure from the gas source.

Some embodiments of the disclosure include a gas regulator for a self-contained or compressed air breathing apparatus, such as typically used by divers, rescue workers, firefighters, paint-booth operators, welders, sandblasters, aircraft workers, chemical plant operators, and others needing breathable air in an environment where breathing is generally dangerous to life or health. Such breathing apparatuses typically have a high-pressure source, such as a tank, interconnected and in fluid communication with an inhalation device. The high-pressure tank usually has an initial pressure of from between about 2,215 to about 4,000 psi. The inhalation device is generally one of a mouthpiece, a mouth mask, a facemask or a combination thereof.

In accordance with some embodiments, the high-pressure tank can have an initial pressure of one of commonly more than about 4,100 psi, more commonly of more than about 4,250 psi, even more commonly of more than about 4,500 psi, yet even more commonly of more than about 5,000 psi, still yet even more commonly of more than about 6,000 psi, still yet even more commonly of more than about 7,000 psi, still yet even more commonly of more than about 8,000 psi, still yet even more commonly of more than about 9,000 psi, still yet even more commonly of more than about 10,000 psi, still yet even more commonly of more than about 11,000 psi, or yet still even more commonly of more than about 12,000 psi.

In accordance with some embodiments, the high-pressure tank can have an initial pressure of between one of generally more than about 4,100 psi, more generally of more than about 4,250 psi, even more generally of more than about 4,500 psi, yet even more generally of more than about 5,000 psi and one of generally no more than about 4,500 psi, yet even more generally of no more than about 5,000 psi, still yet even more generally of no more than about 6,000 psi, still yet even more generally of no more than about 7,000 psi, still yet even more generally of no more than about 8,000 psi, still yet even more generally of no more than about 9,000 psi, still yet even more generally of no more than about 10,000 psi, still yet even more generally of no more than about 11,000 psi, or yet still even more generally of no more than about 12,000 psi.

The high-pressure tank can be an ultra-high-pressure composite tank. The ultra-high-pressure tank can comprise a composite material wall construction. The composite material wall construction can increase structural integrity of the ultra-high-pressure composite tank and achieve a light-weight tank. The increased pressure in such a composite tank can provide over double the breathing time of a single traditional tank. As such, the breathing time of the tank can be substantially increased, in some instances by about a factor of one of about 50%, 75%, 100%, or even more.

The breathable air contained in the tank is typically supplied in accordance with Occupational Safety and Health Standards, specifically according to one of OSHA 1910.134, OSHA 1910.430, Compressed Gas Associate Grade D, Compressed Gas Associate Grade E, Compressed Gas Associate Grade 1, CGA Grade D, NFGA 1989, or combination thereof. In some embodiments, the breathable air comprises one of compressed air, compressed oxygen, liquid air, liquid oxygen, or a combination thereof. In some embodiments, the breathable air meets the United States Pharmacopoeia requirements for medical or breathing oxygen. In some embodiments, the breathable air can have one or more of: an oxygen content (v/v) of from about 19.5 to about 23.5%; a hydrocarbon (condensed) content of about 5 milligrams per cubic meter of air or less; a carbon monoxide (CO) content of about 10 ppm or less; a carbon dioxide content of about 1,000 ppm or less; and no noticeable odor. In some embodiments, the breathable air can have one or more of: a level of carbon monoxide (CO) of no more than about 20 ppm; a level of carbon dioxide (CO₂) of no more than about 1,000 ppm; a level of oil mist of no more than about 5 milligrams per cubic meter; and no noxious or pronounced odor. In some embodiments the breathable air has a dew point not to exceed −50 degrees Fahrenheit. In some embodiments the breathable air has a dew point not to exceed −65 degrees Fahrenheit. Generally, the oxygen content of the breathable gas can be from about 19.5 to 23.5 v/v %, more generally from about 20 to about 22 v/v %. The breathable gas commonly contains one of from about 75 to about 80 v/v % nitrogen, more commonly from about 76.5 to about 80.5 v/v % nitrogen, or even more commonly form about 78 to about 80 v/v %. The carbon monoxide content of the breathable gas can be from about 5 to 10 ppm. In some embodiments, the breathable gas can have a carbon monoxide content of one of no more than about 10 ppm or of no more than about 5 ppm. The carbon dioxide content of the breathable gas can be from about 1,000 to 500 ppm. In some embodiments, the breathable gas can have a carbon dioxide content of one of no more than about 1,000 ppm or of no more than about 500 ppm. The total hydrocarbon content, usually as methane, of the breathable gas is typically no more than about 25 ppm. The breathable gas can have a condensed-oil content of about 5 mg/m³ at NTP. In some embodiments, the breathable gas can have a condensed oil and particulate content of 2 mg/m³ at NPT. The breathable gas can have a nitric oxide content of about 2.5 ppm. The breathable gas can have a nitrous dioxide content of about 2.5 ppm. The breathable gas can have a sulfur dioxide content of about 5 ppm. The water content of the breathable gas can generally be no more than about 67 ppm, more generally no more than about 24 ppm. The dew point of the breathable gas is usually no more than about −50 degrees Fahrenheit, more usually no more than about −65 degrees Fahrenheit.

A self-contained breathing apparatus can be one or more of an open circuit and closed circuit breathing apparatus.

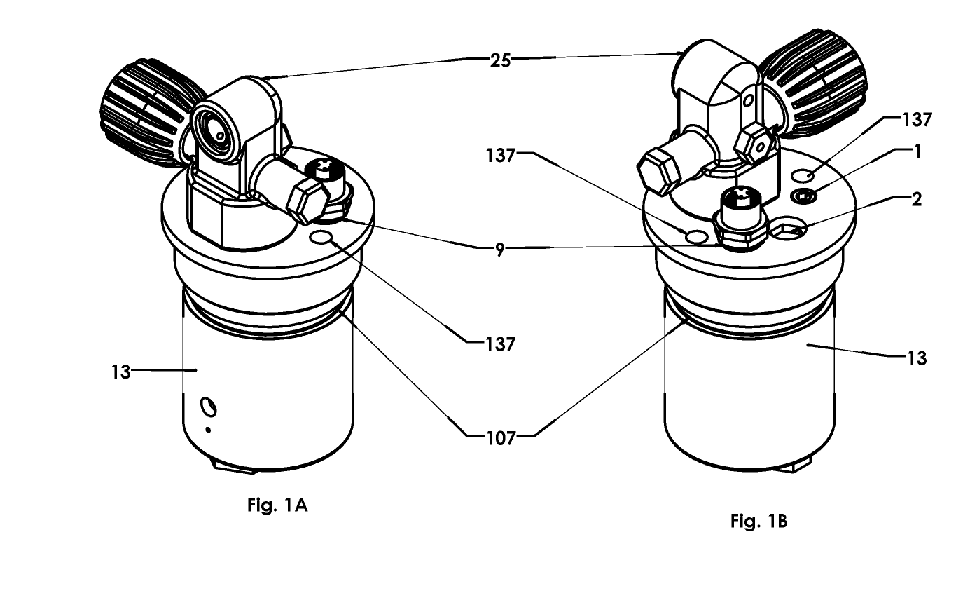

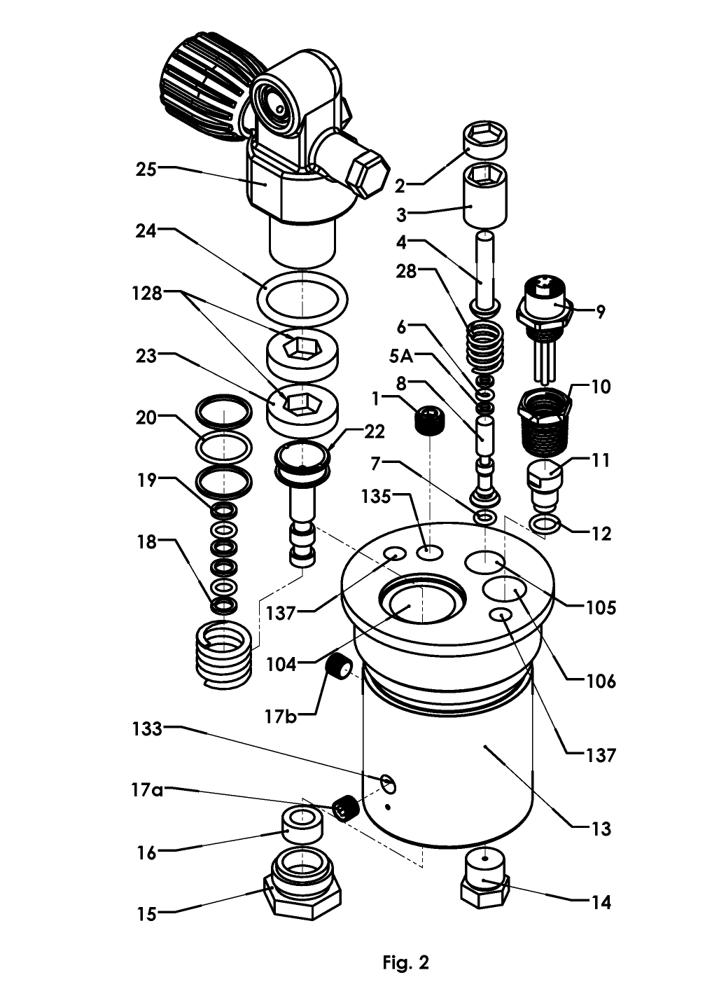

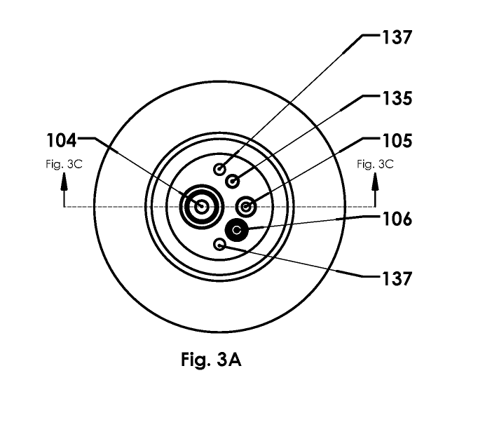

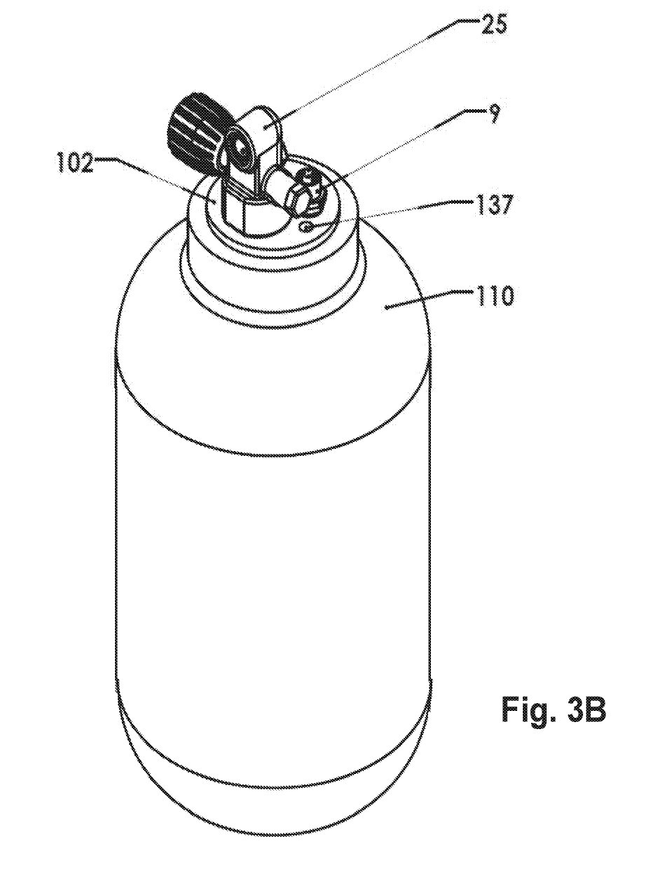

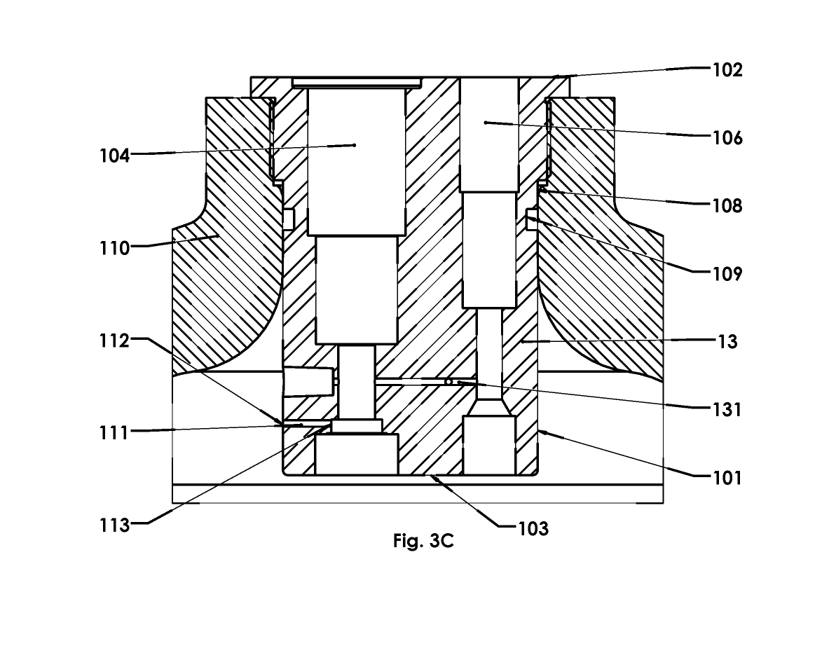

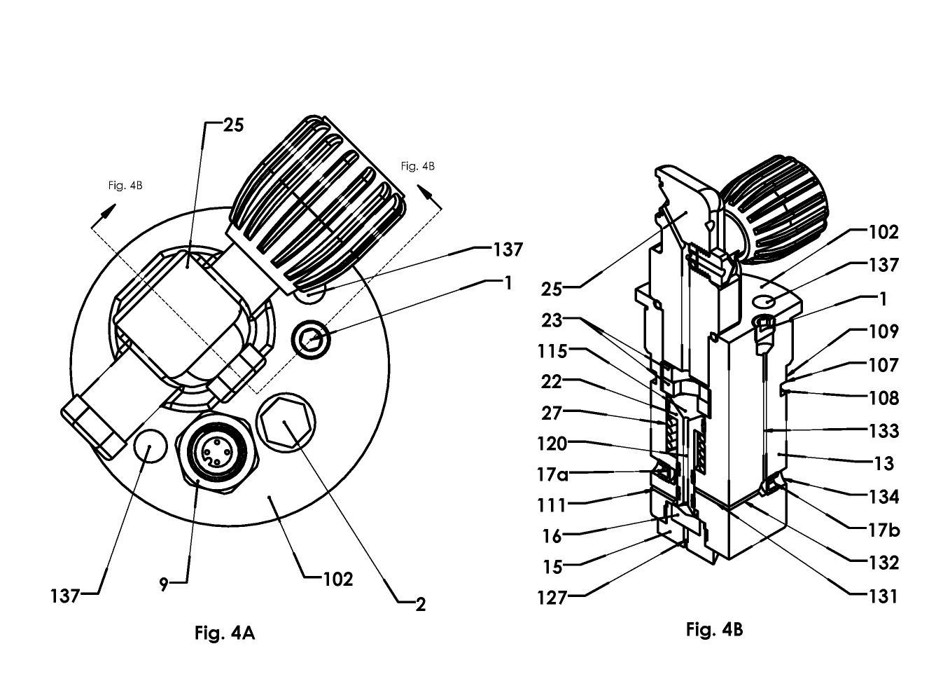

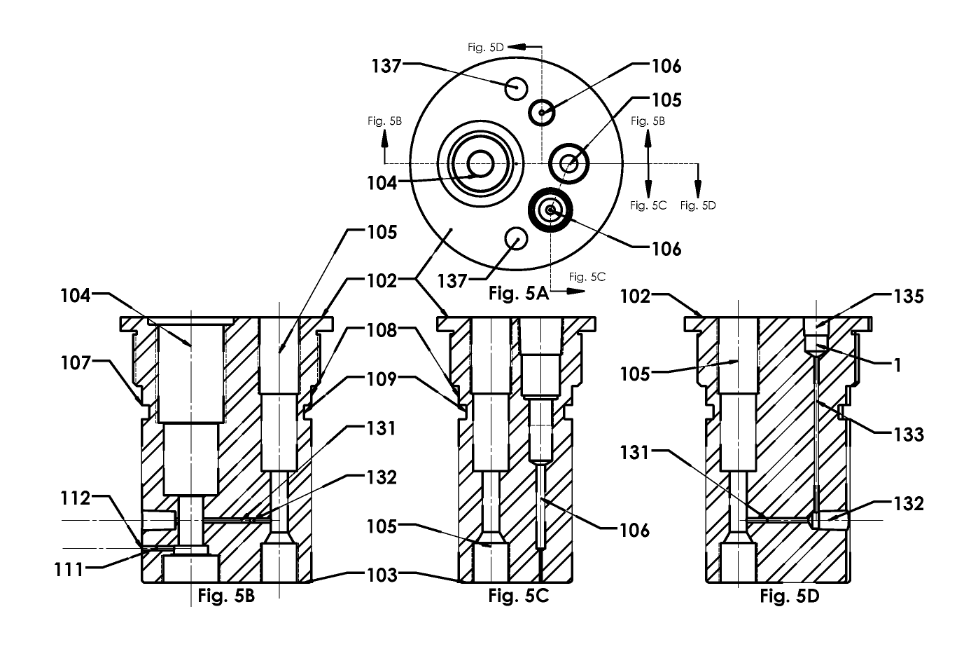

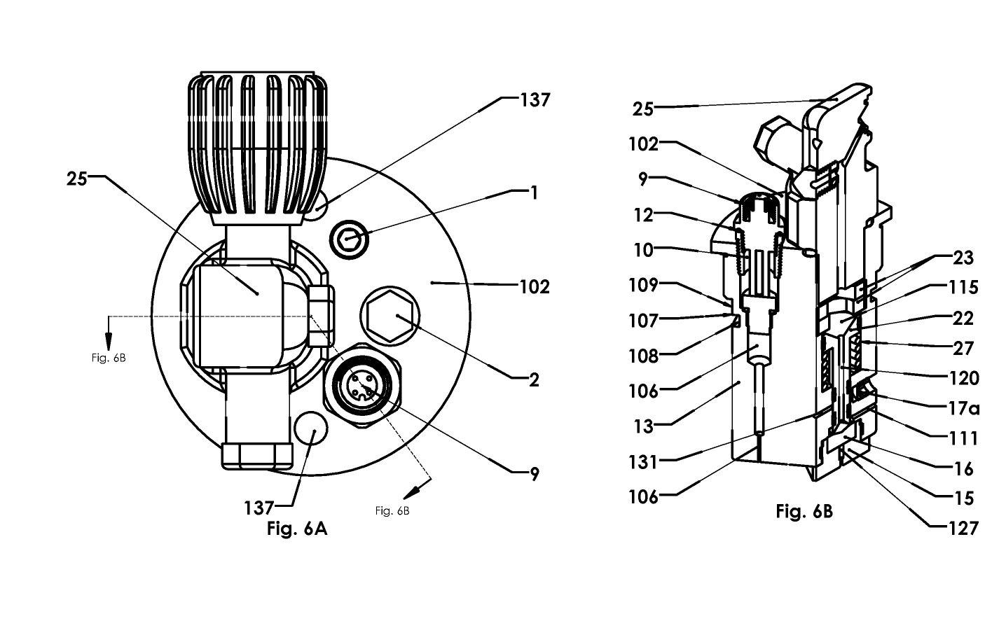

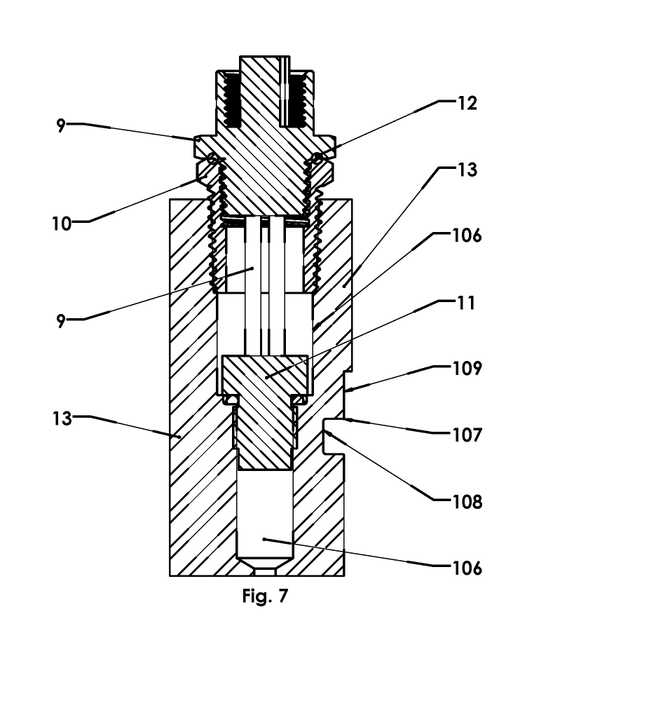

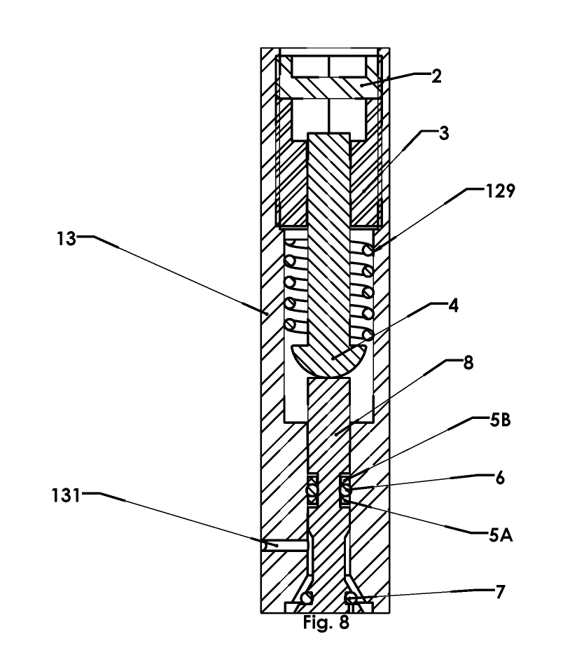

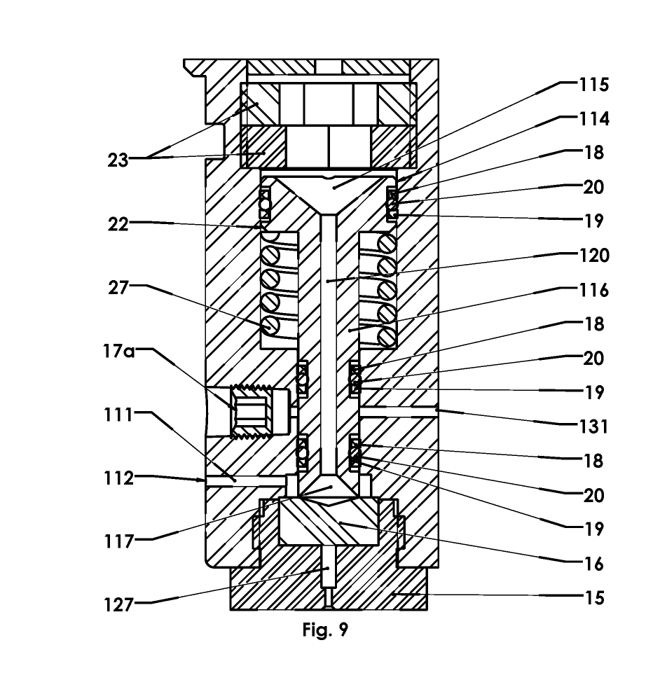

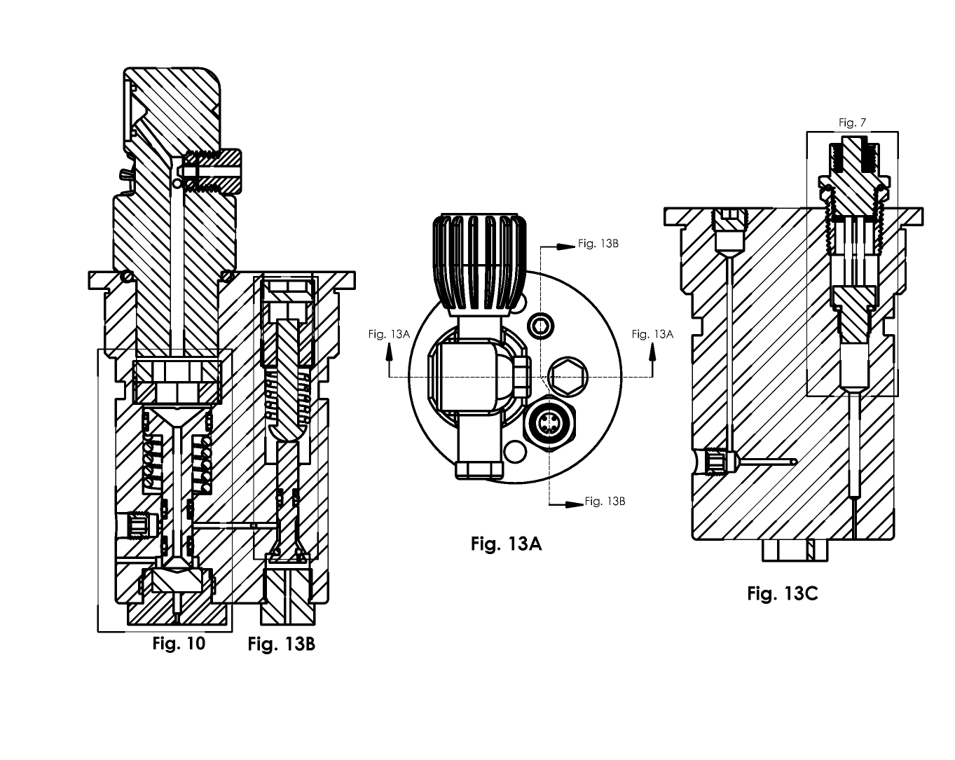

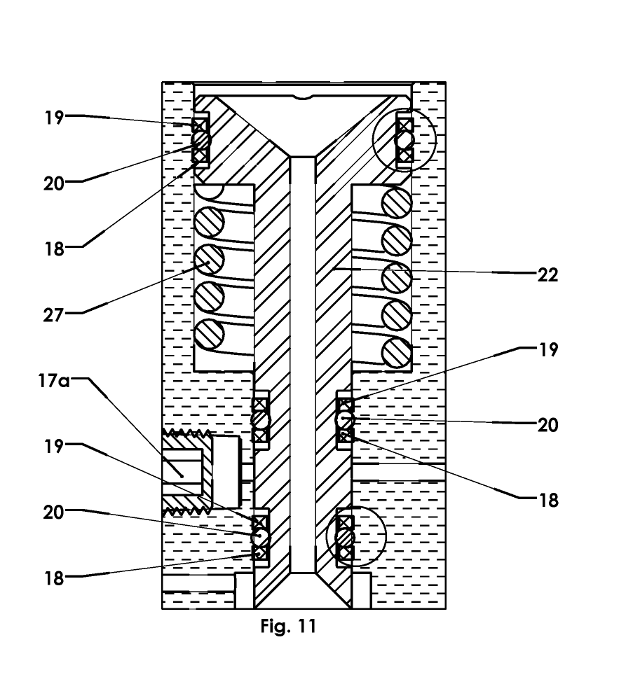

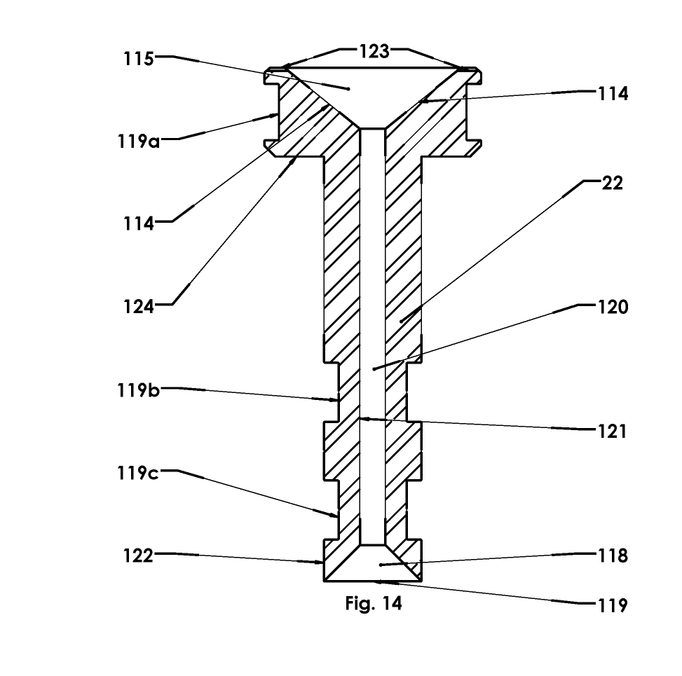

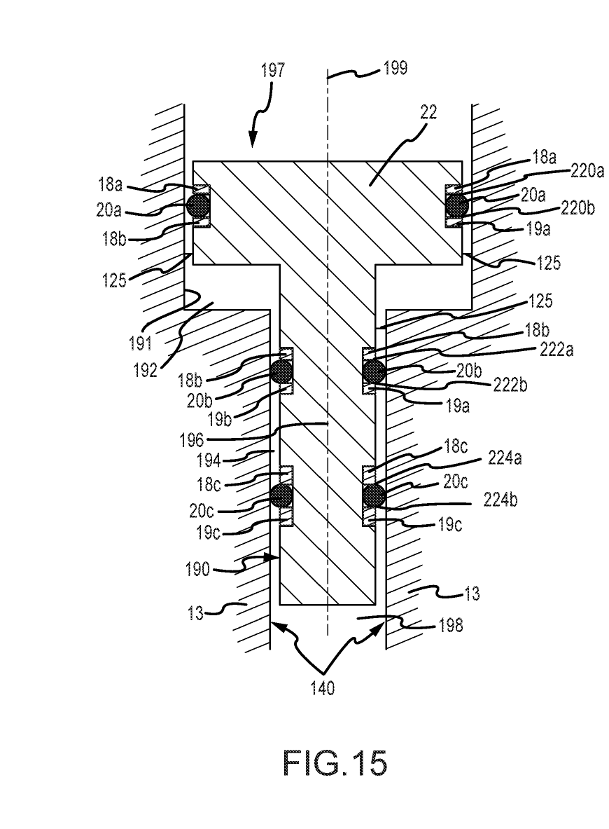

FIGS. 1-15 depict a pressure regulator 100 in accordance with some embodiments of the present disclosure. The pressure regulator 100 comprises a regulator body 13. The regulator body 13 generally has a cylindrical shape with a regulator wall 101 and opposing upper 102 and lower 103 surfaces. Extending through the regulator body 13 from the upper surface 102 to the lower surface 103 surfaces are first 104 and second 105 regulator channels. Generally, a third regulator channel 106 also extends through the regulator body 13. The third regulator channel 106 also extends through the regulator body 13 from the upper surface 102 to the lower surface 103.

The regulator body 13 can comprise one of brass, a brass alloy, aluminum, an aluminum alloy, stainless steel, a stainless steel alloy, a stainless steel SAE Type 303 alloy, a stainless steel SAE Type 304 alloy, or a stainless SAE Type steel 316 alloy. Commonly, the regulator body 13 comprises stainless steel. More commonly, the regulator body 13 comprises a stainless steel alloy. Even more commonly, the regulator body 13 comprises a stainless steel alloy selected from the group consisting essentially of a stainless steel SAE Type 303 alloy, a stainless steel SAE Type 304 alloy, and a stainless steel SAE Type 316 alloy.

The pressure regulator 100 can have a regulator wall groove 107. The regulator wall groove 107 circumscribes the cylindrical wall of the regulator body 13. Generally, the regulator wall groove 107 comprises first 108 and second 109 regulator wall grooves. In some configurations, the first regulator wall groove 108 is deeper than the second regulator wall groove 109. Yet in some configurations, the second regulator wall groove 109 is deeper than the first regulator wall groove 108. Regulator wall groove 107 is configured to interconnect the regulator body 13 to a high-pressure gas source 110. In some configurations, the first 108 and second 109 regulator wall grooves are configured to interconnect the regulator body 13 to a high-pressure gas source 110. The regulator body 13 can be interconnected to the high-pressure gas source 110 by one or more of most commonly, a threaded port with 10,000 psi custom o-ring seal, a bolted flange connection, a flange clamp, or least commonly, a welded interface.

The regulator body 13 commonly has a gas inlet channel 111 interconnected to the first regulator channel 104. It can be appreciated that the gas inlet channel 111 and the first regulator channel 104 are in fluid communication. The gas inlet channel 111 is generally positioned below the regulator wall groove 107 and closer to lower surface 103 than upper surface 102. The gas inlet channel 111 is generally positioned below first 108 and second 109 grooves and closer to lower surface 103 than upper surface 102. The gas inlet channel 111 is commonly in the form of a channel. The gas inlet can have first 112 and second 113 gas inlet apertures. The first gas inlet aperture 112 is commonly position on the regulator wall 101. In some configurations, the first gas inlet aperture 112 can be positioned on lower surface 103 (not depicted in figures). The second gas inlet aperture 113 is positioned on the first regulator channel 104.

The first regulator channel 104 is configured to accept a first piston 22, one or more piston lock washers 23, a loading force element 27, and a piston seat 16. The first piston 22 and the one or more piston lock washers 23 generally comprise one of brass, a brass alloy, aluminum, an aluminum alloy, stainless steel, a stainless steel alloy, a stainless steel SAE Type 303 alloy, a stainless steel SAE Type 304 alloy, or a stainless steel SAE Type 316 alloy. Commonly, the first piston 22 and the one or more piston lock washers 23 comprise stainless steel. More commonly, the first piston 22 and the one or more piston lock washers 23 comprise a stainless steel alloy. Even more commonly, the first piston 22 and the one or more piston lock washers 23 comprise a stainless steel alloy selected from the group consisting essentially of a stainless steel SAE Type 303 alloy, a stainless steel SAE Type 304 alloy, and a stainless steel SAE Type 316 alloy.

The load force element 27 is generally a spring. The load force element 27 usually comprises one of carbon steel, a carbon steel alloy, stainless steel, a stainless steel alloy, a stainless steel SAE Type 303 alloy, a stainless steel SAE Type 304 alloy, or a stainless steel SAE Type 316 alloy. More usually, the load force element 27 comprises a stainless steel alloy selected from the group consisting essentially of a stainless steel SAE Type 303 alloy, a stainless steel SAE Type 304 alloy, and a stainless steel SAE Type 316 alloy. Likewise, the spring generally comprises one of carbon steel, a carbon steel alloy, stainless steel, a stainless steel alloy, a stainless steel SAE Type 303 alloy, a stainless steel SAE Type 304 alloy, or a stainless steel SAE Type 316 alloy. More generally, the spring comprises a stainless steel alloy selected from the group consisting essentially of a stainless steel SAE Type 303 alloy, a stainless steel SAE Type 304 alloy, and a stainless steel SAE Type 316 alloy.

The piston seat 16 can be substantially any material. Typically, the piston seat 16 comprises one of carbon-filled PEEK (polyether ether ketone), carbon-filled CTFE (polychlorotrifluroethylene), fluorocarbon, polytetrafluoroethylene, ethylene propylene diene rubber, silicione, a perfluoroelastomeric material, a polyimide, a polyimide loaded with graphite, a polyimide loaded with graphite and polytetrafluoroethylene, a polyimide loaded with molybdenum disulfide, an unloaded polyimide, a polyimide loaded with 15 wt % graphite, a polyimide loaded with 40 wt % graphite, a polyimide loaded with 15 wt % graphite and 10 wt % polytetrafluoroethylene, a polyimide loaded with 15 wt % molybdenum disulfide. More typically, the piston seat 16 comprises one of a polyimide, a polyimide loaded with graphite, a polyimide loaded with graphite and polytetrafluoroethylene, a polyimide loaded with molybdenum disulfide, an unloaded polyimide, a polyimide loaded with 15 wt % graphite, a polyimide loaded with 40 wt % graphite, a polyimide loaded with 15 wt % graphite and 10 wt % polytetrafluoroethylene, a polyimide loaded with 15 wt % molybdenum disulfide. The piston seat 16 can have a thermal expansion coefficient of from about 34 to about 45×10⁻⁶/K at temperatures from about 211 to about 296 degrees Kelvin and/or from about 38 to about 54×10⁻⁶/K at temperatures from about 296 to about 573 degrees Kelvin. The piston seat 16 can have a thermal conductivity at about 313 degrees Kelvin from about 0.35 to about 1.75 W/mK. More over, the piston seat 16 can have a volume resistivity at about 296 degrees Kelvin of one of from about 10¹² to about 10¹⁵ ohms-m, from about 10¹² to about 10¹³ ohms-m, or from about 10¹⁴ to about 10¹⁵ ohms-m. Furthermore, the piston seat 16 can have a dielectric constant of from about 3.6 to about 13.5 at about 100 Hz, from about 3.65 to about 13.3 at about 10 kHz, from about 3.6 to about 13.4 at 1 MHz, or a combination thereof.

The first piston 22 comprises piston shaft 116 having interior 121 and an exterior 122 walls. The interior wall 121 defines a piston channel 120. One end of the piston shaft 116 has a piston arm 114 extending from the piston shaft 116 and having opposing upper 123 and lower 124 piston arm surfaces. The upper piston arm surface 123 can contain a first countersink piston void 115 interconnect with the piston channel 120. The first countersink piston void 115 and piston channel 120 are in fluid communication. The other end of the piston shaft 116 comprises piston head 118. The piston head 118 is distal to and in an opposing relationship with the piston arm 114. It can be appreciated that the piston head 118 and piston arm 114 are at opposing ends of the piston shaft 116. The piston head 118 can contain a second countersink piston void 117. The second countersink piston void 117 is interconnected with the piston channel 120. It can be further appreciated that the second countersink piston void 117 and the piston channel 120 are in fluid communication. Moreover, the distal end of the piston head 118 has a sharp piston head edge 155. It can be appreciated that in some embodiments the piston channel 120 extends the entire length of the first piston 22 from the upper piston arm surface 123 to the distal end of the piston head 118 sharp piston head edge 155. The first piston 22 can be a moveable piston.

The first piston 22 may or may not have three or more first piston grooves 119a-119c. In some configurations, the first piston 22 may free of any of the three or more first piston grooves 119a-119c.

In some configurations, the first piston may have the three or more first piston grooves 119a-119c. In some embodiments, the first piston arm 114 has the first 119a of the three or more first piston groove and the first piston shaft 116 has the last 119c and an intermediate 119b of the three or more of the first piston grooves. Each of the three or more of the first piston grooves 119a-119c are configured respectively to accept a dynamic pressure seals 20a-c. The dynamic pressure seals 20a-c typically comprise an o-ring. The dynamic pressure seals 20a-c can be selected from the group of o-rings comprising nitrile. buna-N, Viton, EPDM, and perflourolastomer.

Generally, the three or more of the first piston grooves 119a-119c can also be configured to accept a dynamic pressure seals 20a-c positioned between upper 18a-c and lower 19a-c back-up rings. It can be appreciated that the first piston arm 114 can have a circumference that is typically greater than the piston shaft 116 circumference. Hence, the pressure seal 20a and its respective upper 18a and lower 19a back-up rings positioned in the first of the three or more piston groove 119a are greater in size than pressure seals 20b and 20c and their respective upper 18b and 18c and lower 19a and 19c back-up rings positioned in the other of the three or more first piston grooves 119b and 119c.

In some configurations, the first piston 22 can have three piston grooves, a first piston groove 119a, an intermediate piston groove 119b, and a last piston groove 119c. In some embodiments, the first piston arm 114 has the first piston groove 119a and the first piston shaft 116 has the intermediate piston groove 119b and the last piston groove 119c. Each of the three piston grooves 119a-119c are configured to accept respective dynamic pressure seals 20a-20c. The dynamic pressure seals 20a-20c typically comprise o-rings. The dynamic pressure seals 20a-20c can be selected from the group of o-rings comprising nitrile. buna-N, Viton, EPDM, and perflourolastomer.

Generally, the three piston grooves 119a-119c can also be configured, respectively, to accept dynamic pressure seals 20 positioned between upper 18 and lower 19 back-up rings. It can be appreciated that the first piston arm 114 can have a circumference that is typically greater than that of the piston shaft 116 circumference. Hence, the pressure seal 20a and its respective upper 18a and lower 19a back-up rings positioned in the first piston groove 119a are greater in size than pressure seals 20b-20c and their respective upper 18b-18c and lower 19b-19c back-up rings positioned in the intermediate 119b and the last 119c piston grooves.

In some configurations where the first piston is free of any first piston grooves, the first regulator channel 104 contains first regular channel grooves 124a-c. The first regular channel grooves 124a-c are configured to accept the dynamic pressure seals 20a-c. In some configurations, the first regular channel grooves 124a-c are configured to accept a dynamic pressure seal 20 positioned between upper 18 and lower 19 back-up rings.

The first regulator channel 104 can comprise no more than six regulator channel segments 104a-f. The regular channel segment 104a is positioned at the top-end of the regulator channel 104 and is configured to accept valve o-ring 24. Regulator channel segment 104b, which is configured to accept valve 25, is positioned between regulator channels segments 104a and 104c. The regulator channel segment 104c is configured to accept the one or more piston lock washers 23. Immediately below regulator channel segment 104c is regulator channel segment 104d, which is positioned above regulator channel segment 104e.

The one or more piston lock washers 23 are configured to limit movement of the first piston 22, more particularly translational movement of the first piston 22 within the first regulator channel 104. The one or more piston lock washers 23 commonly contain one or more lock washer voids and/or channels 128. Hence, the one or more piston lock washers 23 can allow for fluid communication from one side of one or more lock washers 23 to an opposing side of the one or more lock washers 23.

Regulator channel segment 104d is configured to accept the first piston arm 114 and the loading force element 27. The regulator channel segment 104d extends from at least the upper piston arm surface 123 to no more than the top of the intermediate of the three or more of the first piston groove 119b. In some configurations where first piston 22 has three or more first piston grooves 119a-c, the regulator channel segment 104d is configured to accept the first piston arm 114 with the dynamic pressure seal 20a positioned in the first of the three or more of the piston grooves 119a. In some configurations where the first piston 22 is free of any of the three or more first piston grooves 119a-c, the regulator channel 104d is configured to accept the first piston arm 114 and contains a first regulator channel groove 124a containing a dynamic pressure seal 20a.

The regulator channel 104e, which is positioned between regulator channels 104d and 104f, is configured to accept the first piston shaft 116. The regulator channel 104e extends from at least the top of the intermediate of the three or more of the first piston grooves 119b to the bottom of the last of the three or more of the first piston grooves 119c. In some configurations where first piston 22 has three or more first piston grooves 119a-c, the regulator channel 104e is configured to accept the first piston shaft 116 with the dynamic pressure seals 20b-c positioned respectively in the first piston grooves 119b-c. In some configurations where the first piston 22 is free of any first piston grooves 119a-c, the regulator channel 104e is configured to accept the first piston shaft 116 and contains one or more first regulator channel grooves 124 with each containing a dynamic pressure seal 20.

The dynamic pressure seals 20a-c are sized and configured to create a gap 125 between the first piston 22 and first regulator channel wall 140. The gap 125 can commonly be from one of more than about 0.0005 inch, more commonly more than about 0.001 inch, even more commonly more than about 0.0015 inch, yet even more commonly than about 0.002, still yet even more commonly more than about 0.0025 inch, still yet even more commonly more than about 0.003 inch, still yet even more commonly more than about 0.0035 inch, still yet even more commonly more than about 0.004 inch, still yet even more commonly more than about 0.0045 inch, still yet even more commonly more than about 0.005 inch, still yet even more commonly more than about 0.0055 inch, still yet even more commonly more than about 0.006 inch, still yet even more commonly more than about 0.0065 inch, still yet even more commonly more than about 0.007 inch, still yet even more commonly more than about 0.0075 inch, still yet even more commonly more than about 0.008 inch, still yet even more commonly more than about 0.0085 inch, or yet still even more commonly more than about 0.009 inch to commonly one of no more than about 0.001 inch, more commonly be one of no more than about 0.0015 inch, even more commonly be one of no more than about 0.002 inch, yet even more commonly be one of no more than about 0.0025 inch, still yet even more commonly be one of no more than about 0.003 inch, still yet even more commonly be one of no more than about 0.0035 inch, still yet even more commonly be one of no more than about 0.004 inch, still yet even more commonly be one of no more than about 0.0045 inch, still yet even more commonly be one of no more than about 0.005 inch, still yet even more commonly be one of no more than about 0.0055 inch, still yet even more commonly be one of no more than about 0.006 inch, still yet even more commonly be one of no more than about 0.0065 inch, still yet even more commonly be one of no more than about 0.007 inch, still yet even more commonly be one of no more than about 0.0075 inch, still yet even more commonly be one of no more than about 0.008 inch, commonly be one of no more than about 0.0085 inch, still yet even more commonly be one of no more than about 0.009 inch, still yet even more commonly be one of no more than about 0.0095 inch, or yet still even more commonly be one of no more than about 0.01 inch.

In accordance with embodiments of the present disclosure, the dynamic pressure seals 20a-c substantially impede gas flow from one side 202 of the dynamic pressure seal 20 to the opposing side 204 of the dynamic pressure seal 20. Accordingly, the gas pressure in gap 125 on the one side 202 of the dynamic pressure seal 20 can be greater than the gas pressure on the opposing side 204 of the dynamic pressure seal 20, or vice-a-versa. The dynamic pressure seals in pressure regulators of the prior art commonly fail when the pressure difference between the opposing sides of the pressure seal are greater than about 3,000 to about 5,000 psi. Hence, dynamic pressure seals generally fail when inlet gas (or gas source) pressure is greater than about 5,000 psi and/or when the difference between the inlet gas (or gas source) pressure and outlet gas pressure is greater than about 5,000 psi. The pressure regulator 100 of the present disclosure allows for one or both of inlet gas (or gas source) pressures greater than about 5,000 psi and/or for a difference between the inlet gas (or gas source) pressure and outlet gas pressure of more than about 5,000 psi.

In accordance with some embodiments, the gas pressure on the one side 202 of the dynamic pressure seal 20 is typically one of about 4,000 psi or more than the gas pressure on the opposing side 204 of the dynamic pressure seal 20, more typically about 4,500 psi or more, even more typically about 5,000 psi or more, yet even more typically about 5,500 psi or more, still yet even more typically about 6,000 psi or more, still yet even more typically about 7,500 psi or more, still yet even more typically about 8,000 psi or more, still yet even more typically about 8,000 psi or more, still yet even more typically about 9,000 psi or more, or yet still even more typically about 10,000 psi or more. Generally, the gas pressure on the one side 202 of the dynamic pressure seal 20 is one of more than about 4,000 psi greater than the gas pressure on the opposing side 204 of the dynamic pressure seal 20, more generally more than about 4,500 psi, even more generally more than about 5,000 psi, yet even more generally more than about 5,500 psi, still yet even more generally more than about 6,000 psi, still yet even more generally more than about 6,500 psi, still yet even more generally more than about 7,000 psi, still yet even more generally more than about 8,000 psi, still yet even more generally more than about 9,000 psi, or yet still even more generally more than about 10,000 psi and one of typically no more than about 4,500 psi, more typically no more than about 5,000 psi, even more typically no more than about 5,500 psi, yet even more typically no more than about 6, 000 psi, still yet even more typically no more than about 6,500 psi, still yet even more typically no more than about 7,000 psi, still yet even more typically no more than about 8,000 psi, still yet even more typically no more than about 9,000 psi, still yet even more typically no more than about 10,000 psi, or yet still even more typically no more than about 11,000 psi. In accordance with some embodiments, the gas pressure on the opposing side 204 of the dynamic pressure seal 20 is commonly one of about 4,000 psi or more than the gas pressure on the opposing side 202 of the dynamic pressure seal 20, more commonly about 4,500 psi or more, even more commonly about 5,000 psi or more, yet even more commonly about 5,500 psi or more, still yet even more commonly about 6,000 psi or more, still yet even more commonly about 7,500 psi or more, still yet even more commonly about 8,000 psi or more, still yet even more commonly about 8,000 psi or more, still yet even more commonly about 9,000 psi or more, or yet still even more commonly about 10,000 psi or more.

Regulator channel 104f is configured to accept piston seat retainer 15 and the piston seat 16. The piston seat retainer 15 is configured to contain and retain the piston seat 16. The piston seat retainer 15 can be interconnected to the regulator body 13. Furthermore, the piston seat retainer 15 can have a retainer gas inlet channel 127. The retainer gas inlet channel 127 can allow one side of the piston seat 16 to be subject to the gas source pressure. The gas inlet channel 111 can allow the piston seat side that is in an opposing relationship to the one side of the piston seat to also be subjected to the gas source pressure. Accordingly, the pressure on the one side and the opposing side of the piston seat 16 are at substantially the same pressure. That is the pressures on the one side and the opposing side of the piston seat 16 is substantially are substantially about same, that is both pressures are substantially about the gas source pressure.

Regulator channel 105 is configured to accept a pressure-limiting-valve plug 2, a pressure-limiting-valve spring cap, a pressure-limiting-valve spring 129, a pressure-limiting-valve push rod 4, a pressure-limiting-valve piston 8, and a pressure-limiting-valve retainer 14. The pressure-limiting-valve retainer 14 has a pressure-limiting-valve gas inlet 130. The pressure-limiting-valve gas inlet 130 can allow the gas contained in the gas source to enter a first channel volume 132 of the regulator channel 105. The pressure-liming-valve push rod 4, the pressure-liming-valve spring 129, and the pressure-limiting-valve piston 8 can be configured to allow gas contained in the first channel volume 132 to enter and be in fluid communication with first internal regulator channel 131 and the gap 125 defined the dynamic pressure seals 20b-c to contained in first piston grooves 119b and 119c. Gas contained in the first channel volume 132 can also enter and be in fluid communication with the first internal regulator channel 131 and the gap 125 defined the dynamic pressure seals 20b-c respectively contained in the intermediate 119b and the last 119c of the three or more of the first piston grooves 119b and 119c. Gas can enter and be in fluid communication with the first internal regulator channel 131 and the gap 125 as long as the pressure in the first internal regulator channel 131 and the gap 125 is below the predetermined value. When the pressure of the gas in one or more of the first regulator channel 131 and the gap 125 is one or more of at or below the predetermined pressure value, the pressure-liming-valve push rod 4, the pressure-liming-valve spring 129, and the pressure-limiting-valve piston 8 are configured to substantially block the gas contained in the first channel volume 132 from entering and being in fluid communication with one or more of the first internal regulator channel 131 and the gap 125.

The first internal regulator channel 131 can interconnect a first external wall aperture 132 and the regulator channel 105. A first channel plug 17a can be positioned in the first external wall aperture 132. The first channel plug 17a substantially can seal the first external wall aperture 132 and can substantially not allow any gas to enter the first internal regulator channel 131 through the first external wall aperture 132.

Second 132 and third 133 internal regulator channels can be in fluid communication with the first internal regulator channel 131. The second internal regulator channel 132 can interconnect and can be in fluid communication with the first internal regulator channel 131. The second internal regulator channel 132 can also interconnect a second external wall aperture 134 with the first internal regulator channel 131. A second channel plug 17b can be positioned in the first external wall aperture 134. The second channel plug 17b can substantially seal the second external wall aperture 134 and can substantially not allow gas to enter the second internal regulator channel 132 through the second external wall aperture 134.

The third internal regulator channel 133 can interconnect and can be in fluid communication with the second internal regulator channel 132. The third internal regulator channel 133 can also interconnect a first upper surface aperture 135 with the second internal regulator channel 132 and a third channel plug 1. A third channel plug 1 can be positioned in first upper surface aperture 135. The third channel plug 1 can substantially seal the first upper surface aperture 135 and can substantially not allow any gas to enter the third internal regulator channel 133 through the first upper surface aperture 135.

In some embodiments, the regulator body 13 can contain second 136 and third 137 upper surface apertures. The second 136 and third 137 upper surface apertures are configured to accept a tool for interconnecting the pressure regulator 100 to one or more of a gas source or regulator testing system.

The third regulator channel 106 is generally adapted to accept a pressure transducer 10 and transducer micro-connector 9. The pressure transducer 10 is sealed within the third regulator channel 106 by a transducer o-ring 12 and transducer coupling 10. The pressure transducer 10 is positioned between the transducer o-ring 12 and transducer coupling 10. The transducer-connector 9 is mechanically interconnected to the transducer coupling 10 and electrically interconnected to the pressure transducer 10. In some embodiments, an o-ring is positioned between the transducer micro-connector 9 and the transducer coupling 10.

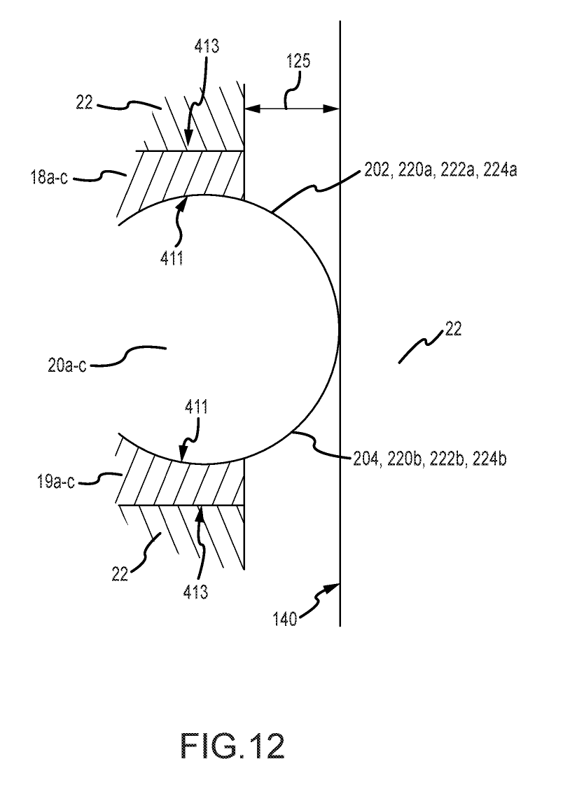

FIG. 12 depicts a dynamic a pressure seal, such as one of dynamic pressure seals 20a-c, positioned respectively between upper 18 and lower back-up rings, such a one of the upper 18a-c and lower 19a-c back-up rings, according some embodiments of the present disclosure. FIG. 12 further depicts a dynamic pressure seal 20 with its upper 18 and lower 19 back-up rings position in a piston groove 119 of piston 22. According to some embodiments, the upper 18 and lower 19 back-up rings each have a contoured surface 411 and an opposing flat surface 413. A dynamic pressure seal 20 is commonly positioned between and in contact with the respective contoured surfaces 411 of the upper 18 and lower 19 back-up rings.

It is believed that controlling one or more of a piston gap distance 125 can substantially increase the pressure difference between 202 and 204 before the dynamic pressure seal 20 fails. For example, selecting one or more of a piston gap distance 125 from the group consisting of from about 0.0005 to about 0.005 inch, 0.0005 to about 0.004 inch, 0.0005 to about 0.003 inch, 0.0005 to about 0.002 inch, from about 0.001 to about 0.004 inch, 0.001 to about 0.003 inch, 0.001 to about 0.002 inch, and from about 0.002 to about 0.003 inch, and can generally increase the difference between 202 and 204 to one of more than about 6,0000 psi, even more generally to more than about 7,000 psi, yet even more generally to more than about 8,000 psi, still yet even more generally to more than about 9,000 psi, still yet even more generally to more than about 10,000 psi, or yet still even more generally to more than about 11,000 psi before the dynamic pressure seal 20 fails.

Stated another way, selecting one or more of a piston gap distance 125 from the group consisting of from about 0.0005 to about 0.005 inch, 0.0005 to about 0.004 inch, 0.0005 to about 0.003 inch, 0.0005 to about 0.002 inch, from about 0.001 to about 0.004 inch, 0.001 to about 0.003 inch, 0.001 to about 0.002 inch, and from about 0.002 to about 0.003 inch, can generally increase the difference between 202 and 204 to typically one of from about 4,000 to about 10,500 psi, more typically from about 5,000 to about 10,000 psi, even more from about 5,000 to about 10,000 psi, yet even more typically from about 6,000 to about 9,50 psi, still yet even more typically from about 6,000 to about 9,000 psi, or yet still even more typically from about 6,500 to about 9,000 psi before the dynamic pressure seal 20 fails.

It can be appreciated that the piston-based regulator 100, a piston 22, spring 27, and piston seat 16 act together to seal the high-pressure inlet gas from the low-pressure outlet 150, accomplished by balancing pressure forces acting on the piston 22. When the outlet pressure is low, the spring forces the piston 22 off the piston seat 16, opening the regulator for gas flow. Gas flows through the piston 22, increasing the outlet pressure. When the outlet pressure reaches the set point, the increased gas pressure forces the piston 22 against the seat 16, stopping gas flow. In current first-stage piston type scuba regulators, a single o-ring between the piston and regulator body is used to create a seal preventing unwanted flow of high-pressure gas to the spring housing. These o-rings, while capable of maintaining a pressure differential typical in current scuba systems (of about 3,000 to about 4,000 psi), would rupture if employed at pressure from about 5,000 to about 10,000 psi.

In accordance with some embodiments is a regulator 100. The regulator 100 can include a first regulator channel 104 configured to accept a first piston 22 generally having a first piston groove 119a, a last piston groove 119c, and an intermediate piston groove 119b positioned between the first 119a and last piston grooves 119c. The regulator 100 can also include a gas inlet channel 111 interconnected to the first regulator channel 104 and having a gas inlet channel pressure. The last piston groove 119c is commonly positioned adjacent to the gas inlet channel 111. The last piston groove 119c can contain a last dynamic pressure-sealing element 20c having opposing upper 224a and lower 224b last dynamic pressure-sealing element surfaces. The regulator 100 can include a gas outlet channel 150 having a gas outlet channel pressure. The gas inlet channel 111 and the gas outlet channel 150 are generally in fluid communication. The first piston groove 119a is typically positioned adjacent to the gas outlet channel 150. The first piston groove 119a contains a first dynamic pressure-sealing element 20a having opposing upper 220a and lower 220b first dynamic pressure-sealing element surfaces. The intermediate piston groove 119b usually contains an intermediate dynamic sealing element 20b having opposing upper 222a and lower 222b intermediate dynamic sealing element surfaces. The regulator 100 can also include a second regulator channel 105 generally having a second fluid pressure. The second regulator channel can commonly be in fluid communication with the upper last dynamic pressure-sealing element surface 224a (positioned in the first piston groove 119c) and to the lower intermediate dynamic pressure-sealing element surface 222b (positioned in the intermediate first piston groove 119b). The lower last dynamic pressure-sealing element surface 224b (positioned in the last piston groove 119c) is commonly subjected to the gas inlet pressure. The upper first dynamic pressure-sealing element surface 220a (positioned in the last piston groove 119a) is commonly subjected to the gas outlet pressure. Moreover, the upper last dynamic pressure-sealing element surface 224a (positioned in the first piston groove 119c) and the lower intermediate dynamic pressure-sealing element surface 222b (positioned in the intermediate piston groove 119b) are at the second fluid pressure. The lower first dynamic pressure-sealing element surface 220b (positioned in the last piston groove 119a) and the upper intermediate dynamic pressure-sealing element 222a (positioned in the intermediate first piston groove 119b) are at a first fluid pressure. Furthermore, the inlet pressure is greater than one or both of the first and second fluid pressures. Moreover, the outlet pressure is no greater than one or both of first and second fluid pressures.

The first dynamic pressure-sealing element 20a is usually positioned between upper 18a and lower 19b first back-up rings. The intermediate dynamic pressure-sealing element 20b is commonly positioned between upper 18b and lower 19b intermediate back-up rings. The last dynamic pressure-sealing element 20c is typically positioned between upper 18c and lower 19c last back-up rings. The first dynamic pressure-sealing element 20a can be an o-ring. The first dynamic pressure-sealing element 20a can be a nitrile o-ring. The intermediate dynamic pressure-sealing element 20b can be an o-ring. The intermediate dynamic pressure-sealing element 20b can be a nitrile o-ring. The last dynamic pressure-sealing element 20c can be an o-ring. The last dynamic pressure-sealing element 20c can be a nitrile o-ring.

Commonly, the gas outlet channel 150 pressure can be from about 100 psi to about 500 psi. More commonly, the gas outlet channel 150 pressure can be from about 120 psi to about 150 psi.

Typically, the gas inlet channel 111 pressure can be from about 4,500 psi to about 10,000 psi. More typically, the gas inlet channel 111 pressure can be from about 5,000 psi to about 10,000 psi.

Commonly, the second fluid pressure can be from about 1,500 to about 5,000 psi. More commonly, the second fluid pressure can be from about 2,000 to about 5,000 psi. Even more commonly, the second fluid pressure can be from about 3,000 to about 5,000 psi. Yet even more commonly, the second fluid pressure can be about 5,000 psi. Still yet even more commonly, the second fluid pressure can be about 4,000 psi. Yet still even more commonly, the second fluid pressure can be about 6,000 psi.

The first fluid pressure can generally be about 1 atm at STP. More generally the first fluid pressure can be from about 0.8 to about 1 atm at STP.

In some embodiments, the second regulator channel 105 can be configured to accept a pressure-limiting-valve plug 2, a pressure-limiting-valve spring cap 3, a pressure-limiting-valve spring 129, a pressure-limiting-valve push rod 4, a pressure-limiting-valve piston 8, and a pressure-limiting-valve retainer 14. Furthermore, the pressure-limiting-valve plug 2 can seal the pressure-limiting-valve spring cap 3, pressure-limiting-valve spring 129, pressure-limiting-valve push rod 4, pressure-limiting-valve piston 8, and pressure-limiting-valve retainer 14 in the second regulator channel 105. The pressure-limiting valve spring cap 3 can have a spring cap void 151. Moreover, the pressure-limiting-valve push rod 4 can have a push rod stem 152 interconnected to a push rod head 153. A portion of the push rod stem 152 is typically contained within the spring cap void 151. Furthermore, the pressure-limiting-valve spring 129 can be positioned between the pressure-limiting valve spring cap 3 and the push rod head 153. The push rod head 153 can be in contact with one end of the pressure-limiting-valve piston 8. The pressure-limiting-valve retainer 14 can be in contact with the other end of pressure-limiting-valve piston 8.

The first regulator channel 104 can be configured to accept, in addition to the first piston 22, one or more piston lock washers 23, a loading force element 27, a piston seat 16, and a piston seat retainer 15. The one or more lock washers 23 can contain one or more lock washer voids and/or channels 128. Moreover, first piston 22 can have a piston shaft 116. The piston shaft 116 can have at one end a piston arm 114 and at other end a piston head 118. The piston arm 114 and piston head 118 can be in an opposing relationship. The first piston 22 can be positioned between the one or more lock washers 23 and the piston seat 16. The loading-force element 27 can contain a loading-force element void 154. A portion of the piston shaft 116 can be positioned in the loading-force element void 154. The piston seat 16 can be positioned between the piston head 118 and the piston seat retainer 15.

In accordance with some embodiments is system having an inlet channel 111 for introducing a pressurized gas having an inlet gas pressure. The inlet gas pressure can apply a lifting force to a first piston 22 contained within a first regulator channel 104. The applied lifting force can also break a gas-tight seal between a first piston seat 16 and the first piston 22. Moreover, the inlet gas pressure can also apply the inlet gas pressure to a lower last dynamic pressure-sealing element surface 224b of a last dynamic pressure-sealing element 20c. Furthermore, the inlet gas pressure can introduce the pressurized gas into a first piston channel 120 to flow the pressurized gas to a gas outlet 150 and convert the inlet gas pressure to an outlet gas pressure. The inlet gas pressure can be greater than outlet pressure. Moreover, the first piston channel 120 traverses a first piston longitudinal axis. The system can also include a second regulator channel 105 for applying a second fluid pressure to both the upper last dynamic pressure-sealing element surface 224a and to a lower intermediate dynamic pressure-sealing element surface 222b. The upper 224a and lower 224b last dynamic pressure-sealing surfaces are typically in an opposing relationship. The inlet gas pressure can be applied to the lower last dynamic pressure-sealing element surface 224b. Moreover, the outlet gas pressure can be applied to upper first dynamic pressure-sealing element surface 220a. The system can generally include a first pressurized gas to apply a first fluid pressure to lower first dynamic pressure-sealing element surface 220b and the upper intermediate dynamic pressure-sealing element surface 222a. The inlet pressure can be greater than one or both of the first and second fluid pressures. The outlet pressure can be no greater than one or both of first and second fluid pressures.

The first dynamic pressure-sealing element 20a is usually positioned between upper 18a and lower 19b first back-up rings. The intermediate dynamic pressure-sealing element 20b is commonly positioned between upper 18b and lower 19b intermediate back-up rings. The last dynamic pressure-sealing element 20c is typically positioned between upper 18c and lower 19c last back-up rings. The first dynamic pressure-sealing element 20a can be an o-ring. The first dynamic pressure-sealing element 20a can be a nitrile o-ring. The intermediate dynamic pressure-sealing element 20b can be an o-ring. The intermediate dynamic pressure-sealing element 20b can be a nitrile o-ring. The last dynamic pressure-sealing element 20c can be an o-ring. The last dynamic pressure-sealing element 20c can be a nitrile o-ring.

Commonly, the pressure applied by the outlet gas pressure can be from about 100 psi to about 500 psi. More commonly, the pressure applied by the outlet gas pressure is from about 120 psi to about 150 psi.

Generally, pressure applied by the inlet gas pressure can be from about 4,500 psi to about 10,000 psi. More generally, the pressure applied by the inlet gas pressure can be from about 5,000 psi to about 10,000 psi.

The pressure applied by the first fluid pressure can typically be about 1 atm at STP. More typically, the pressure applied by the first fluid pressure can be from about 0.8 to about 1 atm at STP.

In some embodiments, the second regulator channel 105 can be configured to accept a pressure-limiting-valve plug 2, a pressure-limiting-valve spring cap 3, a pressure-limiting-valve spring 129, a pressure-limiting-valve push rod 4, a pressure-limiting-valve piston 8, and a pressure-limiting-valve retainer 14. Furthermore, the pressure-limiting-valve plug 2 can seal the pressure-limiting-valve spring cap 3, pressure-limiting-valve spring 129, pressure-limiting-valve push rod 4, pressure-limiting-valve piston 8, and pressure-limiting-valve retainer 14 in the second regulator channel 105. The pressure-limiting valve spring cap 3 can have a spring cap void 151. Moreover, the pressure-limiting-valve push rod 4 can have a push rod stem 152 interconnected to a push rod head 153. A portion of the push rod stem 152 is typically contained within the spring cap void 151. Furthermore, the pressure-limiting-valve spring 129 can be positioned between the pressure-limiting valve spring cap 3 and the push rod head 153. The push rod head 153 can be in contact with one end of the pressure-limiting-valve piston 8. The pressure-limiting-valve retainer 14 can be in contact with the other end of pressure-limiting-valve piston 8.

The first regulator channel 104 can be configured to accept, in addition to the first piston 22, one or more piston lock washers 23, a loading force element 27, a piston seat 16, and a piston seat retainer 15. The one or more lock washers 23 can contain one or more lock washer voids and/or channels 128. Moreover, first piston 22 can have a piston shaft 116. The piston shaft 116 can have at one end a piston arm 114 and at other end a piston head 118. The piston arm 114 and piston head 118 can be in an opposing relationship. The first piston 22 can be positioned between the one or more lock washers 23 and the piston seat 16. The loading-force element 27 can contain a loading-force element void 154. A portion of the piston shaft 116 can be positioned in the loading-force element void 154. The piston seat 16 can be positioned between the piston head 118 and the piston seat retainer 15.

In accordance with some embodiments is a device that includes a first regulator channel 104 configured to accept a first piston 22 having a first piston groove 119a, a last piston groove 119c, and an intermediate piston groove 119b positioned between the first 119a and last 119c piston grooves. The last piston groove 119c can contain a last dynamic pressure-sealing element 20c having upper 224a and lower 224b last dynamic pressure-sealing element surfaces. The upper last dynamic pressure-sealing element surface 224a can be subjected to a second pressure. The lower last dynamic pressure-sealing element surface 224b can be subjected to a fourth pressure. The first and fourth pressures exert different pressure forces on the last dynamic pressure-sealing element 20c. The intermediate piston groove 119b can contain an intermediate dynamic pressure-sealing element 20b can have upper 222a and lower 222b second dynamic pressure-sealing element surfaces. The upper intermediate dynamic pressure-sealing element surface 222a can be subjected to the first pressure. The lower dynamic pressure-sealing element surface 222b can be subjected to the second pressure. The second and first pressures can exert different pressure forces on the intermediate dynamic pressure-sealing element 20b. The first piston groove 119a can contain a first dynamic pressure-sealing element 20a having upper 220a and lower 220b first dynamic pressure-sealing element surfaces. The upper first dynamic pressure-sealing element surface 220a can be subjected to a third pressure. The lower first dynamic pressure-sealing element surface 220a can be subjected to the first pressure. The third and first pressures exert different pressure forces on the first dynamic pressure-sealing element 20a. The fourth pressure is more than first pressure.

The first pressure can generally be about 1 atm at STP. More generally the first pressure can be from about 0.8 to about 1 atm at STP.

Commonly, the second pressure can be from about 1,500 to about 5,000 psi. More commonly, the second pressure can be from about 2,000 to about 5,000 psi. Even more commonly, the second pressure can from about 3,000 to about 5,000 psi. Even more commonly, the second pressure can be about 5,000 psi. Yet even more commonly, the second pressure can be about 4,000 psi. Still yet even more commonly, the second pressure can be about 6,000 psi.

Commonly, the third pressure can be from about 100 psi to about 150 psi. More commonly, the gas outlet channel 150 pressure can be from about 120 psi to about 150 psi.

Generally, fourth pressure can be from about 4,500 psi to about 10,000 psi. More generally, the fourth pressure can be from about 5,000 psi to about 10,000 psi. Even more generally, the fourth pressure can be from about 6,000 to about 10,000 psi. Yet even more generally, the fourth pressure can be from about 7,000 to about 10,000 psi.

In some embodiments, the first regulator channel 104 can be configured to accept in addition to the first piston 22, one or more piston lock washers 23, a loading force element 27, and a piston seat 16.

The first dynamic pressure-sealing element 20a is usually positioned between upper 18a and lower 19b first back-up rings. The intermediate dynamic pressure-sealing element 20b is commonly positioned between upper 18b and lower 19b intermediate back-up rings. The last dynamic pressure-sealing element 20c is typically positioned between upper 18c and lower 19c last back-up rings. The first dynamic pressure-sealing element 20a can be an o-ring. The first dynamic pressure-sealing element 20a can be a nitrile o-ring. The intermediate dynamic pressure-sealing element 20b can be a nitrile o-ring. The last dynamic pressure-sealing element 20c can be a nitrile o-ring.

In some embodiments, the device can further include a first upper back-up ring 18a. The first upper back-up ring 18a can have a first upper back-up ring 18a flat ring surface 413 and an upper first back-up ring 18a contoured surface 411. The first upper back-up flat ring surface 413a and the first upper back-up ring 18a contoured surface 411 can be in an opposing relationship. Moreover, the device can also include a first lower back-up ring 19a. The first lower back-up ring 19a can have a first lower back-up flat ring 19a flat surface 413 and a lower first back-up ring 19a contoured surface 411. The first lower back-up ring 19a flat ring surface 413 and the first lower back-up ring 19a contoured surface 411 can generally be in an opposing relationship. The first dynamic pressure-sealing element 20a can be in contact with the upper first back-up ring 18a contoured surface 411 and the lower first back-up ring 19a contoured surface 411.

In some embodiments, the device can further include an intermediate upper back-up ring 18b. The intermediate upper back-up ring 18b can have an intermediate upper back-up ring 18b flat surface 413 and an upper intermediate back-up ring 18b contoured surface 411. The intermediate upper back-up ring 18b flat surface 413 and the intermediate upper back-up ring 18b contoured surface 411 can be in an opposing relationship. Moreover, the device can also include an intermediate lower back-up ring 19b. The intermediate lower back-up ring 19b can have an intermediate lower back-up ring 19b flat surface 413 and a lower intermediate back-up ring 19b contoured surface 411. The intermediate lower back-up ring 19b flat surface 413 and the intermediate lower back-up ring 19b contoured surface 411 can be in an opposing relationship.

In some embodiments, the intermediate dynamic pressure-sealing element 20b can be an o-ring. The intermediate dynamic pressure-sealing element 20b is usually in contact with the upper intermediate back-up ring 19b contoured surface 411 and the lower intermediate back-up ring 19b contoured surface 411.

In accordance with some embodiments, the device can further include a last upper back-up ring 18c. The last upper back-up ring 18c can have a last upper back-up ring 18c flat surface 413 and an upper last back-up ring 18c contoured surface 411. The last upper back-up ring 18c flat surface 413 and the last upper back-up ring 18c contoured surface 411 can be in an opposing relationship. Moreover, the device can further include a last lower back-up ring 19c. The last back-up ring 19c can have a last lower back-up ring 19c flat surface 413 and a lower last back-up ring 19c contoured surface 411. The last lower back-up ring 19c flat surface 413 and the last lower back-up ring 19c contoured surface 411 can be in an opposing relationship.

In some embodiments, the last dynamic pressure-sealing element 20c can be an o-ring. The last dynamic pressure-sealing element 20c is typically in contact with the upper last back-up ring 18c contoured surface 411 and the lower last back-up ring 19c contoured surface 411.

Commonly, the first, second, third and fourth pressures are gas pressures. The first gas can have a first gas pressure. That is, the first gas can exert a first gas pressure. The second gas can have a second gas pressure. That is, the second gas can exert a second gas pressure. The third gas can have a third gas pressure. That is, the third gas can exert a third gas pressure. The fourth gas can have a fourth gas pressure. That is, the fourth gas can exert a fourth gas pressure.

In accordance with some embodiments of the present disclosure is a device that includes a first regulator channel 104 configured to accept a first piston 22. The first piston 22 can having a first piston groove 119a, a last piston groove 119c, and an intermediate piston groove 119b positioned between the first 110a and last 119c piston grooves. Furthermore, the first piston 22 can have an exterior piston wall 122. The first regulator channel 104 can have a first regulator channel wall 140. The first piston groove 119a can contain a first dynamic pressure-sealing element 20a, the first dynamic pressure-sealing element 20a can have upper 220a and lower 220b first dynamic pressure-sealing element surfaces. The intermediate piston groove 119b can contain an intermediate dynamic pressure-sealing element 20b, the intermediate dynamic pressure-sealing element 20b can have upper 222a and lower 222b intermediate dynamic pressure-sealing element surfaces. The last piston groove 119c can contain a last dynamic pressure-sealing element 20c, the last dynamic pressure-sealing element 20c can have upper 224a and lower 224b last dynamic pressure-sealing element surfaces.

In accordance with some embodiments is a second regulator volume 192 defined by a second portion 193 of the exterior piston wall 190, a second portion 191 of the first regulator channel wall 140, the lower first dynamic pressure-sealing element surface 220b, and the upper intermediate dynamic pressure-sealing element surface 222a. The second regulator volume 192 typically contains a first fluid at a first fluid pressure.

In accordance with some embodiments is a first regulator volume 194 defined by a first portion 195 of the exterior piston wall 190, a first portion 196 of the first regulator channel wall 140, the lower intermediate dynamic pressure-sealing element surface 222b, and the upper last dynamic pressure-sealing element surface 224a.

Some embodiments can include a second regulator channel 105 containing a second fluid at a second fluid pressure. The second regulator channel 105 can be in fluid communication with the second regulator volume 192. Furthermore, second regulator volume 192 can contain the second fluid at the second fluid pressure. The first and second fluid pressures can differ in pressure.

In some embodiments, the device can further include a third regulator volume 197. The third regulator volume can contain the second fluid at a third fluid pressure.

In some embodiments, the device can further include a fourth regulator volume 198. The fourth regulator volume can contain the second fluid at a fourth fluid pressure.

Commonly, the fourth fluid pressure is greater than the third fluid pressure. Generally, the third fluid is a breathable gas supplied by a high-pressure gas source. The high-pressure gas source can usually be a high-pressure tank. More usually, the high-pressure tank can be a self-contained breathing apparatus tank.

Commonly, the third fluid pressure can be from about 5000 psi to about 5000 psi. More commonly, the gas outlet channel 150 pressure can be from about 1000 psi to about 3000 psi.

Typically, the fourth fluid pressure can be from about 4,500 psi to about 10,000 psi. More typically, the second fluid pressure can be from about 5,000 psi to about 10,000 psi. Even more typically, the second fluid pressure is from about 6,000 to about 10,000 psi.

Commonly, the second fluid pressure can be from about 1,500 to about 5,000 psi. More commonly, the second fluid pressure can be from about 2,000 to about 5,000 psi. Even more commonly, the second fluid pressure can from about 3,000 to about 5,000 psi. Even more commonly, the second fluid pressure can be about 5,000 psi. Yet even more commonly, the second fluid pressure can be about 4,000 psi. Still yet even more commonly, the second fluid pressure can be about 6,000 psi.

The first fluid pressure can generally be about 1 atm at STP. More generally the first fluid pressure can be from about 0.8 to about 1 atm at STP. Typically, the first fluid pressure is about 1 atm when the second regulator volume 192 is constructed. More typically, the first fluid pressure is about from about 0.8 to about 1 atm at STP when the second regulator volume 192 is constructed.

In some embodiments, the second regulator channel 105 can be configured to accept a pressure-limiting-valve plug 2, a pressure-limiting-valve spring cap 3, a pressure-limiting-valve spring 129, a pressure-limiting-valve push rod 4, a pressure-limiting-valve piston 8, and a pressure-limiting-valve retainer 14. Furthermore, the pressure-limiting-valve plug 2 can seal the pressure-limiting-valve spring cap 3, pressure-limiting-valve spring 129, pressure-limiting-valve push rod 4, pressure-limiting-valve piston 8, and pressure-limiting-valve retainer 14 in the second regulator channel 105. The pressure-limiting valve spring cap 3 can have a spring cap void 151. Moreover, the pressure-limiting-valve push rod 4 can have a push rod stem 152 interconnected to a push rod head 153. A portion of the push rod stem 152 is typically contained within the spring cap void 151. Furthermore, the pressure-limiting-valve spring 129 can be positioned between the pressure-limiting valve spring cap 3 and the push rod head 153. The push rod head 153 can be in contact with one end of the pressure-limiting-valve piston 8. The pressure-limiting-valve retainer 14 can be in contact with the other end of pressure-limiting-valve piston 8.

The first regulator channel 104 can be configured to accept, in addition to the first piston 22, one or more piston lock washers 23, a loading force element 27, a piston seat 16, and a piston seat retainer 15. The one or more lock washers 23 can contain one or more lock washer voids and/or channels 128. Moreover, first piston 22 can have a piston shaft 116. The piston shaft 116 can have at one end a piston arm 114 and at other end a piston head 118. The piston arm 114 and piston head 118 can be in an opposing relationship. The first piston 22 can be positioned between the one or more lock washers 23 and the piston seat 16. The loading-force element 27 can contain a loading-force element void 154. A portion of the piston shaft 116 can be positioned in the loading-force element void 154. The piston seat 16 can be positioned between the piston head 118 and the piston seat retainer 15.

Typically, the first and second fluids are gases. More typically, the first and second fluids are breathable gases. Even more typically, the first and second fluids are breathable gases having from about 75 to about 80 v/v % nitrogen, from about 19 to about 24 v/v % oxygen. Yet even more typically, the first and second fluids differ in one or more of composition and source. Generally, the second fluid source is a high-pressure tank. Usually, the first fluid source is the ambient atmosphere when the second regulator volume 192 is constructed.

In some embodiments, the device can further include a first upper back-up ring. The first upper back-up ring can have a first upper back-up ring 18a flat surface 413 and a upper first back-up ring 18a contoured surface 413. The first upper back-up ring 18a flat surface 413 and the first upper back-up ring 18a contoured surface 411 can be in an opposing relationship. Moreover, the device can also include a first lower back-up ring 19a. The first lower back-up ring 19a can have a first lower back-up ring 19a flat surface 413 and a lower first back-up ring 19a contoured surface 413. The first lower back-up ring 19a flat surface 413 and the first lower back-up ring 19a contoured surface 413 can generally be in an opposing relationship. The first dynamic pressure-sealing element 20a can be in contact with the upper first back-up ring 18a contoured surface 411 and the lower first back-up ring 19a contoured surface 411.

In some embodiments, the device can further include an intermediate upper back-up ring 18b. The intermediate upper back-up ring 18b can have an intermediate upper back-up ring 18b flat surface 413 and a upper intermediate back-up ring 18b contoured surface 411. The intermediate upper back-up ring 18b flat surface 413 and the intermediate upper back-up ring 18b contoured surface 411 can be in an opposing relationship. Moreover, the device can also include an intermediate lower back-up ring 19b. The intermediate lower back-up ring 19b can have a second lower back-up ring 19b flat surface 413 and a lower intermediate back-up ring 19b contoured surface 411. The intermediate lower back-up ring 19b flat surface 413 and the intermediate lower back-up ring 19b contoured surface 411 can be in an opposing relationship.

In some embodiments, the intermediate dynamic pressure-sealing element 20b can be an o-ring. The intermediate dynamic pressure-sealing element 20b is usually in contact with the upper intermediate back-up ring 18b contoured surface 411 and the lower intermediate back-up ring 19b contoured surface 411.

In accordance with some embodiments, the device can further include a last upper back-up ring 18c. The last upper back-up ring 18c can have a last upper back-up ring 18c flat surface 413 and a upper last back-up ring 18c contoured surface 411. The last upper back-up ring 18c flat surface 413 and the last upper back-up ring 18c contoured surface 411 can be in an opposing relationship. Moreover, the device can further include a last lower back-up ring 19c. The last lower back-up ring 19c can have a last lower back-up ring 19c flat surface 413 and a lower last back-up ring 19c contoured surface 411. The last lower back-up ring 19c flat surface 413 and the last lower back-up ring 19c contoured surface 411 can be in an opposing relationship.

In some embodiments, the last dynamic pressure-sealing element 20c can be an o-ring. The last dynamic pressure-sealing element 20c is typically in contact with the upper third back-up ring 18c contoured surface 43 and the lower third back-up ring 19c contoured surface 411.

In accordance with some embodiments is a method that includes in a regulator 100 having first piston 22 positioned in a first regulator channel 105, the first piston 22 having a first piston channel 120 in fluid communication with a gas inlet 111 having a fourth gas pressure and gas outlet 150 having a third gas pressure. In some embodiments, the first piston 22 is moveable. Some embodiments, in a first piston position, flow of the gas through the first piston channel 120 is substantially blocked when the third gas pressure at the gas outlet 150 is above a selected pressure, and, in a second piston position, flow of the gas through the first piston channel 120 is permitted until the gas pressure at the gas outlet 150 is at the third pressure less than the selected pressure, maintaining, when the first piston 22 is in both the first and second piston positions, a first gas pressure between a first 119a and intermediate 119b piston grooves. Some embodiments can include maintaining, when the movable piston is in both the first and second piston positions, a second gas pressure between the intermediate 119b and last 119c piston grooves. The intermediate piston groove 119b can be positioned between the first 119a and last 119c piston grooves. The second gas pressure can be greater than the first gas pressure. In some embodiments, each of the first gas pressure, second gas pressure, gas inlet pressure and gas outlet pressure are different from one another.

As described herein, an intermediate chamber can have mediate pressure differentials of more than about 4,000 psi, such as pressure from about 5,000 to about 10,000 psi. By including such an intermediate chamber and one or more additional o-rings between the piston 22 and regulator body, the additional pressure can be stepped-down to an intermediate pressure (such as but not limited to about 5,000 psi) before reaching the spring housing, which is open to ambient pressure. In such configurations, each o-ring experiences a maximum pressure differential of no more than about 5,000 psi, and thus allowing for regulators capable of withstanding higher pressures. The configurations described herein are not limited to a single intermediate pressure chamber, as multiple pressure chambers could be implemented to reduce the pressure differential experienced by any given o-ring further or to increase the maximum operating pressure. The intermediate chamber is pressure controlled by an integrated pressure-limiting valve that feeds the chamber between the high and low-pressure chambers. The pressure-limiting valve is configured such that as the tank is filled the valve is open until the set point (such as but not limited to about 5,000 psi) pressure is attained. Once the set-point pressure is reached the valve closes, sealing the intermediate pressure chamber. Alternatively, as the pressure drops (such as during use), the pressure-limiting valve will remain closed until the tank pressure drops below the set point, at which point the valve opens, maintaining appropriate pressure differentials across the respective o-rings.

The regulator as described herein allows for pressure to be reduced from the high pressure inlet (5,000 psi or more) to the low-pressure outlet (for example 2,000 psi). In this configuration, channeling and intermediate chambers are implemented to provide step-down pressures along the piston. This enables the use of o-rings to hold an overall pressure of more than about 5,000 psi pressure differential between the high pressure inlet and the ambient pressure spring housing. The pressures in the above-described intermediate chambers are maintained by a pressure-limiting valve to control the pressure differentials across piston o-rings. These o-rings allow the piston to actuate while maintaining a seal between the various pressure chambers.

The piston design needs to accommodate for extremely high pressures of the inlet gas, up to and possibly more than about 10,000 psi. The piston 22 actuates, allowing high-pressure gas to flow and expand to a decreased pressure appropriate for feeding a standard first-stage regulator (having an operating pressure of from about 500 to about 3,000 psi). The piston 22 operates by opening or closing by balancing the forces of high and low pressure gas with that of a compressed spring. When the piston closes, it needs to properly seat and seal to prevent the flow of gas. The seat material, design, and shape to maintain a seal between the high and low-pressure sides of the regulator.

A number of variations and modifications of the invention can be used. It would be possible to provide for some features of the invention without providing others. The present invention, in various embodiments, configurations, or aspects, includes components, methods, processes, systems and/or apparatus substantially as depicted and described herein, including various embodiments, configurations, aspects, sub-combinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A system, comprising:
an inlet channel for introducing a pressurized gas having an inlet gas pressure, wherein the inlet pressure:
(i) applies a lifting force to a first piston contained within a first regulator channel, wherein the applying of the lifting force breaks a gas-tight seal between a first piston seat and the first piston;
(ii) applies the inlet gas pressure to a lower last dynamic pressure-sealing element surface of a last dynamic pressure-sealing element, and
(iii) introduces the pressurized gas into a first piston channel to:
(a) flow the pressurized gas to an outlet; and
(b) convert the inlet gas pressure to an outlet gas pressure, wherein the inlet gas pressure is greater than outlet pressure, wherein the first piston channel traverses the first piston longitudinal axis;
a second regulator channel for applying a second fluid pressure to both the upper last dynamic pressure-sealing element surface and to a lower intermediate dynamic pressure-sealing element surface, wherein the upper and lower last dynamic pressure-sealing element surfaces are in an opposing relationship,
wherein the inlet gas pressure is applied to the lower last dynamic pressure-sealing element surface,
wherein the outlet gas pressure is applied to an upper first dynamic pressure-sealing element surface, wherein the upper and lower first dynamic pressure-sealing element surfaces are in an opposing relationship,
a first pressurized gas to apply a first fluid pressure to a lower first dynamic pressure-sealing element surface and the upper intermediate dynamic pressure-sealing element surface,
wherein the inlet pressure is greater than one or both of the first and second fluid pressures, and
wherein the outlet pressure is no greater than one or both of first and second fluid pressures.

2. The system of claim 1, wherein the first dynamic pressure-sealing element is positioned between upper and lower first back-up rings, wherein the intermediate dynamic pressure-sealing element is positioned between upper and lower intermediate back-up rings, and
wherein the last dynamic pressure-sealing element is positioned between upper and lower last back-up rings.

3. The system of claim 1, wherein the first, intermediate and last dynamic pressure-sealing elements comprise o-rings.

4. The system of claim 1, wherein the pressure applied by the outlet gas pressure is from about 500 psi to about 5000 psi.

5. The system of claim 1, wherein the pressure applied by the outlet gas is from about 100 to about 500 psi.

6. The system of claim 1, wherein the pressure applied by the inlet gas pressure is from about 4,500 psi to about 10,000 psi.

7. The system of claim 1, wherein the pressure applied by the second fluid pressure is from about 3,000 to about 5,000 psi.

8. The system of claim 1, wherein the pressure applied by the second fluid pressure is from about 1,500 to about 5,000 psi.

9. The system of claim 1, wherein the pressure applied by the first fluid pressure is about 1 atm at STP.

10. The gas regulator of claim 1, wherein the second regulator channel is configured to accept a pressure-limiting-valve plug, a pressure-limiting-valve spring cap, a pressure-limiting-valve spring, a pressure-limiting-valve push rod, a pressure-limiting-valve piston, and a pressure-limiting-valve retainer, wherein the pressure-limiting-valve plug seals the pressure-limiting-valve spring cap, pressure-limiting-valve spring, pressure-limiting-valve push rod, pressure-limiting-valve piston, and pressure-limiting-valve retainer in the second regulator channel, wherein the pressure-limiting spring cap has a spring cap void, wherein the pressure-limiting-valve push rod has push rod stem interconnected to a push rod head, wherein a portion of the push rod stem is contained within the spring cap void, wherein the pressure-limiting-valve spring is positioned between the pressure-limiting valve spring cap and the push rod head, wherein is in contact with one end of the pressure-limiting-valve piston, wherein the pressure-limiting-valve retainer is in contact with the other end of pressure-limiting-valve piston, wherein the first regulator channel is configured to accept, in addition to the first piston, one or more piston lock washers, a loading force element a piston seat, and a piston seat retainer, wherein each of the one or more lock washers contain one or more lock washer voids and/or channels, wherein the first piston has a piston shaft having at one end a piston arm and at other end a piston head, wherein the piston arm and piston head are in an opposing relationship, wherein first piston is positioned between the one or more lock washers and the piston seat, wherein the loading-force element contains a loading-force element void, wherein a portion of the piston shaft is positioned in the loading-force element void, and wherein the piston seat is positioned between the piston head and the piston seat retainer.

11. A device, comprising:
a first regulator channel configured to accept a first piston having a first piston groove, a last piston groove, and an intermediate piston groove positioned between the first and last piston grooves;
wherein the last piston groove contains a last dynamic pressure-sealing element having upper and lower last dynamic pressure-sealing element surfaces, wherein the upper last dynamic pressure-sealing element surface is subjected to a second pressure, wherein the lower last dynamic pressure-sealing element surface is subjected to a fourth pressure, wherein the fourth and second pressures exert different pressure forces on the last dynamic pressure-sealing element,
wherein the intermediate piston groove contains an intermediate dynamic pressure-sealing element having upper and lower intermediate dynamic pressure-sealing element surfaces, wherein the upper intermediate dynamic pressure-sealing element surface is subject to the first pressure, wherein the lower intermediate dynamic pressure-sealing element surface is subject to the second pressure, wherein the second and first pressures exert different pressure forces on the intermediate dynamic pressure-sealing element,
wherein the first piston groove contains a first dynamic pressure-sealing element having upper and lower first dynamic pressure-sealing element surfaces, wherein the upper first dynamic pressure-sealing element surface is subject to a third pressure, wherein the lower first dynamic pressure-sealing element surface is subject to the first pressure, wherein the third and first pressures exert different pressure forces on the first dynamic pressure-sealing element, and
wherein the fourth pressure is more than first pressure.

12. The device of claim 11, wherein the first regulator channel is configured to accept in addition to the first piston, one or more piston lock washers, a loading force element, and a piston seat.

13. The device of claim 11, wherein each of first, second, and third dynamic pressure-sealing elements are positioned between upper and lower back-up rings.

14. The device of claim 11, wherein the first, second, and third dynamic pressure-sealing elements are o-rings.

15. The device of claim 11, further comprising:
a first upper back-up ring having a first upper back-up flat ring surface and a upper first back-up ring contoured surface, wherein the first upper back-up flat ring surface and the first upper back-up ring contoured surface are in an opposing relationship; and
a first lower back-up ring having a first lower back-up flat ring surface and a lower first back-up ring contoured surface, wherein the first lower back-up flat ring surface and the first lower back-up ring contoured surface are in an opposing relationship, and
wherein the first dynamic pressure-sealing element is an o-ring, wherein the first dynamic pressure-sealing element is in contact with the upper first back-up ring contoured surface and the lower first back-up ring contoured surface.

16. The device of claim 11, further comprising:
an intermediate upper back-up ring having an intermediate upper back-up flat ring surface and a upper second back-up ring contoured surface, wherein the intermediate upper back-up flat ring surface and the intermediate upper back-up ring contoured surface are in an opposing relationship; and
an intermediate lower back-up ring having an intermediate lower back-up flat ring surface and a lower intermediate back-up ring contoured surface, wherein the intermediate lower back-up flat ring surface and the intermediate lower back-up ring contoured surface are in an opposing relationship, and
wherein the intermediate dynamic pressure-sealing element is an o-ring, wherein the intermediate dynamic pressure-sealing element is in contact with the upper intermediate back-up ring contoured surface and the lower intermediate back-up ring contoured surface.

17. The device of claim 11, further comprising:
a last upper back-up ring having a last upper back-up flat ring surface and a upper last back-up ring contoured surface, wherein the last upper back-up flat ring surface and the last upper back-up ring contoured surface are in an opposing relationship; and
a last lower back-up ring having a last lower back-up flat ring surface and a lower last back-up ring contoured surface, wherein the last lower back-up flat ring surface and the last lower back-up ring contoured surface are in an opposing relationship, and
wherein the last dynamic pressure-sealing element is an o-ring, wherein the last dynamic pressure-sealing element is in contact with the upper last back-up ring contoured surface and the lower last back-up ring contoured surface.

18. The device of claim 11, wherein the first, second, third and fourth pressures are gas pressures.

19. The device of claim 11, wherein the first pressure comprises a first gas pressure exerted by a first gas, wherein the second pressure comprises a second gas pressure exerted by a second gas, wherein the third pressure comprises a third gas pressure exerted by a third gas, and wherein the fourth pressure comprises a fourth gas pressure exerted by a fourth gas.

20. A method, comprising:
in a regulator having first piston positioned in a first regulator channel, the first piston having a first piston channel in fluid communication with a gas inlet having a fourth gas pressure and gas outlet having a third gas pressure, wherein the first piston is moveable, wherein, in a first piston position, flow of the gas through the first piston channel is substantially blocked when a third gas pressure at the gas outlet is above a selected pressure, and, in a second piston position, flow of the gas through the first piston channel is permitted and the gas pressure at the gas outlet is at the third pressure and less than the selected pressure, maintaining, when the first piston is in both the first and second piston positions, a first gas pressure between a first and intermediate piston grooves; and
maintaining, when the movable piston is in both the first and second piston positions, a second gas pressure between the intermediate and last piston grooves, wherein the intermediate piston groove is positioned between the first and last piston grooves, wherein the second gas pressure is greater than the first gas pressure, and wherein the each of the first gas pressure, second gas pressure, gas inlet pressure and gas outlet pressure are different from one another.

21. The method of claim 10, wherein the outlet gas pressure is from about 500 psi to about 5000 psi.

22. The method of claim 20, wherein the gas outlet pressure is from about 100 to about 500 psi.

23. The method of claim 20, wherein the pressure applied by the inlet gas pressure is from about 4,500 psi to about 10,000 psi.

24. The method of claim 20, wherein the pressure applied by the second fluid pressure is from about 3,000 to about 5,000 psi.

25. The method of claim 20, wherein the pressure applied by the second fluid pressure is from about 1,500 to about 5,000 psi.

26. The method of claim 20, wherein the pressure applied by the first fluid pressure is about 1 atm at STP.
